(19) United States
(12) Patent Application Publication
(10) Pub. No.: US 2003/0023580 A1
(43) Pub. Date: Jan. 30, 2003

(54) Method and system for assimilating data from ancillary preumbra systems onto an enterprise system

(76) Inventors: Kristopher P. Braud, Baton Rouge, LA (US); J. Eric Schoonmaker, Baton Rouge, LA (US)

Correspondence Address: Rudolph J. Buchel, Jr., Jones, Day, Reavis & Pogue, P. O. Box 660623, 2727 N. Harwood Street, Dallas, TX, 75266-0623, US

(21) Appl. No.: 09/825,051

(22) Filed: Apr. 3, 2001

(51) Int. Cl. G06F 7/00

(52) U.S. Cl. 707/3

(57) ABSTRACT

The present invention provides a means for an enterprise, such as a health care facility, to transfer preumbra enterprise data from any one of a plurality of disparate, ancillary vendor applications to a requestor. The particular strategy used for transferring the preumbra data depends on the type of preumbra data and how that data is formatted in the ancillary preumbra system database. Some ancillary preumbra system databases organize the preumbra data such that very little data processing is necessary by the enterprise application whenever the preumbra is retrieved. Those systems store preumbra data in a manner that is extremely conducive with accessing the preumbra data from the respective ancillary system's database in real-time and therefore can be accessed upon a request being received for the preumbra data. Some other ancillary preumbra systems store preumbra data such that it is impossible to access the requested preumbra data, aggregate it and then prepare it for presentation in near real-time. Additionally, aggregating the preumbra data needed for computing some line items might require accessing multiple preumbra data entries in the ancillary penumbra system's database. The preumbra data stored in those ancillary system databases must be accessed periodically and the preumbra data processed (aggregated) and then stored in a preumbra/enterprise database for subsequent delivery to a user upon receiving a request.

### CROSS REFERENCES TO RELATED APPLICATIONS

The present application is related to the following co-pending U.S. patent applications:

U.S. patent application entitled, “METHOD AND SYSTEM FOR ASSIMILATING DATA FROM DISPARATE, ANCILLARY SYSTEMS ONTO AN ENTERPRISE SYSTEM”, having application No. ______, attorney docket No. 017017-620002 and filed on Mar. 30, 2001, currently pending and which is assigned to the assignee of the present invention. The above-entitled application is incorporated by reference in its entirety.

### BACKGROUND OF THE INVENTION

1. Field of the Invention

The present invention relates generally to information services systems and more particularly to assimilating and accessing data stored in ancillary support systems. Still more particularly, the recent invention relates to the distribution and administration of supporting information services by presenting and/or accessing information at an enterprise level, which has been entered and stored in an ancillary system level. Still further, the present invention relates to optimally retrieving applications level data from ancillary support systems based on wherein the communication is performed at an applications level.

2. Description of Related Art

A commercial enterprise, or enterprise, may be defined as a unit of economic organization or activity, especially a business organization for undertaking a project, especially a difficult, complicated or risky project. An enterprise may evolve in response to a need, which has been unfulfilled. Thus, the underlying goal of any enterprise is to successfully complete a common project or task. However, many commercial enterprises are compilations of enterprise departments that evolve to fulfill sub-tasks of the enterprise's primary task. These enterprise departments may originate autonomously from the enterprise to provide a solution for a task or instead, a department may be created internally by the enterprise for more effectively focusing on a particular sub-task. Independent enterprise departments may be acquired by an enterprise to supplement the enterprise's innate capacity. When properly integrated, the roles of individual enterprise departments are largely unrelated and dissimilar to other enterprise departments. The individual enterprise departments are supported by functional disparate systems.

One of ordinary skill in the art will understand that each of these enterprise departments may evolve its own particular infrastructure and culture. Individual enterprise departments most probably establish their own Information Systems Service (ISS) infrastructures based solely on their own information processing needs and budget constraints and without regard to the ISS needs of other enterprise departments. A department institutes its own information priori that shape its information system requirements. Individual enterprise departments establish relationships with hardware and software vendors based on that priori and set IS personal standards based on the vendor's products. As the role of the department changes within the enterprises, the department's vendors adjust their products accordingly, thus allowing the department to maintain or increase its market share in comparison to similar, but competing enterprise departments. Over the course of time, a department's vendor supplied applications become unique from other enterprise department's vendor supplied applications as each application provides ancillary functionality to all other department applications within the enterprise. In practice, the disparate, ancillary character of enterprise department applications and database structures is often beneficial to the enterprise because each department's applications are allowed to focus on the department's information priori with minimal interference from the enterprise of other department's information priori.

On the other hand, the information product of one department might be needed by another department for that department to expedite its enterprise sub-tasks. Therefore, a department needing another department's information product must either train its IS personnel on that department's applications or rely on that department to respond on request for its information product. Since enterprise departments relied on diverse vendor applications predicated on dissimilar information priori, information structures laced the coherence necessary for straightforward data exchange.

Problems, other than at the system level, also developed in the prior art. Enterprise department information products have an additional disadvantage of being system level data images. An enterprise level perspective of an information solution is difficult to achieve because it would be necessary for an enterprise user to understand the data images from all disparate, ancillary system's products that service the enterprise. Finding an enterprise level information solution is problematical because most enterprises rely on their enterprise departments for IS solutions thus, rarely does an enterprise establish an enterprise level information priori.

Aside from problems associated with hierarchical information levels, enterprise users needing to access system level data and functionality must be competent with a variety of disparate, ancillary applications. Any user needing data from a system must be competent with that system in order to utilize the disparate system interfaces for drilling down into individual department data structures. Many enterprise IS personnel are not overly proficient with a variety of disparate, ancillary applications and non-IS enterprise users are even less competent. Therefore, it is often left to the individual enterprise department to provide the necessary skilled IS personnel to interface with enterprise users needing system level data and functionality. Reliance on individual enterprise departments to access their disparate, ancillary systems for responding to enterprise user requests may result in a lag between the enterprise level query and a system level response from a department, as well as increasing the likelihood of a miscommunication between the enterprise user and a department's IS specialist. Maintaining a duplicative force of department IS personnel in each disparate, ancillary system to respond to enterprise users also increases the IS overhead for the disparate enterprise departments.

The aforementioned disparate, ancillary systems provide support for departments that are intended to provide an enterprise with a core group of services that directly related to the mission of the enterprise, or the enterprise umbra. These services are critical to the enterprise completing its mission. However, an enterprise, especially a large corporate enterprise, relies on other support systems for fulfilling non-critical functions. These include a myriad of record keeping functions related to finance, employees, government regulations, etc. and results in the generation of numerous enterprise tracking records. Exemplary enterprise records may include enterprise profitability reports, financial income statements, budget variance reports, accounts payable distribution reports, labor distribution reports, employee leave reports, employee time card data and employee demographics information. While these functions do not fall directly under the umbra of the enterprise mission, they do fall under the preumbra of services necessary for an enterprise to be efficient and ensure long-term profitability and even its survival.

As with the umbra disparate, ancillary systems, an enterprise user needing data from a system must be competent with that system in order to utilize the disparate system interfaces for drilling down into individual department data structures. It is even more unlikely that a direct line manager of an enterprise department would become proficient with an ancillary application devoted to the support of preumbra data as that data is not mission critical. Thus, as a practical matter, most enterprise users cannot concern themselves with learning a non-mission critical application to the extent necessary to drill down and recover data important to the user's department. Therefore, most users rely on the enterprise to make the preumbra data available to the department. Preumbra data is conveyed to an enterprise department in one of three ways: first, the enterprise user becomes proficient with the ancillary preumbra systems; second, the enterprise migrates all existing applications, both umbra and preumbra, to a unified standard interface where enterprise users need to become proficient with one graphical interface which usually involves the enterprise scrapping its existing ancillary IS and implement an enterprise-wide IS platform from a single vendor; and finally, allowing each ancillary preumbra system to periodically generate hard copy reports that are then circulated to the respective enterprise departments. The latter of the three is the most widespread scheme for disseminating non-critical preumbra data to enterprise departments. Because real-time preumbra data is normally not necessary for an enterprise to successfully accomplish its mission, an enterprise can normally postpone the cost of implementing an enterprise-wide, single vendor solution until even one or more mission critical disparate, ancillary system applications needs upgrading. Even the many enterprise directors cannot justify the expense of migrating to a single vendor platform, especially when many ancillary preumbra application vendors provide superior products to single vendor enterprise-wide application solutions which would result in an ongoing loss due to lower productivity from the inferior IS preumbra product.

In addition to the solutions described above, often enterprise standards groups attempted to accommodate preumbra data by implementing proprietary segments in their messaging protocols. The HL7 standard group is one such example and the propriety segment structure of the HL7 message is described below. Of course, the HL7 standard does not define a specification for preumbra data, only for umbra data related to the enterprise's core business, healthcare. It was hoped that by including the means for enterprise administrators to perform preumbra data transfers by using a portion of the protocol that administrators would be encouraged to develop their own auxiliary specifications for individual vendor ancillary preumbra applications being employed in their enterprise. However, these efforts were largely ineffective because in order to for the HL7 messaging protocol to be effective, as a data transfer means for preumbra data, the enterprise's ancillary preumbra applications must be event triggered and very few are. Additionally, most enterprises are perfectly content to continue distributing copies of the ancillary system's reports and data by hard copy via email, thereby saving the expense on problems associated with defining and maintaining a new auxiliary messaging specification.

With respect to the health care services industry, the prior art attempts to solve many of the aforementioned shortcomings by eliminating the disparate, ancillary applications and application databases and utilizing an enterprise level application and application level database. By adopting an enterprise information priori, enterprise departments were forced to gradually migrate their ancillary applications toward the enterprise standard and gradually disband their legacy applications.

Of general background interest to the present invention are the following references. U.S. Pat. No. 5,867,821 issued to Ballantyne, et al. on Feb. 2, 1999 titled, “Method and Apparatus for Electronically Accessing and Distributing Personal Health Care Information and Services in Hospitals and Homes”. This reference describes a distribution and administration system that is interconnected to a master library (ML). The master library stores data in a digital compressed format through a local medical information network. The patient/medical personnel interact with this medical information network through a patient's individual electronic patient care station (PCS) that is interconnected to the master library PCS and receives the requested service or data from the master library. The requested data is then displayed either on the associated television set or video monitor or through wireless/IR communications to a peripheral personal data assistant (pen based computer technology). The data for text, audio and video information is all compressed digitally to facilitate distribution and only decompressed at the final stage before viewing/interaction.

In another example, U.S. Pat. No. 5,748,907 issued to Crane on May 5, 1998 titled, “Medical Facility And Business: Automatic Interactive Dynamic Real-Time Management” utilizes an Interactive Dynamic Real-Time Management System including a microprocessor adapted to sense the automatic interaction of real-time inputs. These real-time inputs relate to the method of controlling the position, flow of patients, employees, invoicing, appointment scheduling, and financial costs. With this automatic interactive management system, it also controls time, space and tasks routinely of a medical clinic or other types of businesses. A memory stores historical data related to the interaction of the real-time inputs and the microprocessor compares sensed real-time information with historical data to determine changes in unknown operating parameters. All information from real-time dynamic interacting, automatic, semiautomatic and manual inputs are fed into a master processor where the information is automatically sent to patients, employees, and other businesses in the network.

U.S. Pat. No. 6,055,506 issued to Frasca, Jr. on Apr. 25, 2000 titled, “Outpatient Care Data System” utilizes a plurality of metropolitan-area data systems operatively connected to a regional data system. Each of the metropolitan area data systems is located at a different metropolitan location and is dedicated to the transmission, storage and retrieval of outpatient data relating to the care of outpatients and is provided with a regional data system located at a regional location. Each metropolitan area data system may be provided with an electronic nursing station located within a hospital and first and second types of outpatient systems operatively coupled to the electronic nursing station on a real-time basis. A data storage system is located at a hospital which stores outpatient data in the form of a plurality of medical records for a plurality of outpatients associated with the outpatient care data system. For each outpatient, these medical records include an identification of the outpatient and data relating to the medical history of the outpatient.

In still another example of the prior art, U.S. Pat. No. 5,724,580 issued to Levin, et al. on Mar. 3, 1998 titled, “System And Method Of Generating Prognosis And Therapy Reports For Coronary Health Management” describes a system and method for automatically formulating an alpha-numeric comprehensive management and prognosis report at a centralized data management center for a patient at a remote location. Levin, et al. describes converting information regarding the condition of the patient into data, transferring the data to the centralized data management center and receiving the data. Then, generating the comprehensive management and prognosis report based on analysis of the data. A storage means is also provided at the centralized data management center for maintaining a record of the data received by and transmitted from the centralized data management center in a relational data base format.

In still another example, U.S. Pat. No. 5,301,105 issued to Cummings, Jr. on Apr. 5, 1994 tilted, “All Care Health Management System” describes a fully integrated and comprehensive health care system. That health care system includes integrated interconnection and interaction of the patient, health care provider, bank or other financial institution, insurance company, utilization reviewer and employer so as to include within a single system each of the essential participants to provide patients with complete and comprehensive pre-treatment, treatment and post-treatment health care and predetermined financial support therefor. A processing system(s) contains substantial memory storage capacity and the system employs such memory storage capacity to record a number of important bodies of data and other information. These data bodies may either be a part of the memory of the processing system or may be in other data banks that are accessible to the processing system.

Finally, U.S. Pat. No. 6,112,183 issued to Swanson, et al. on Aug. 29, 2000 titled, “Method And Apparatus For Processing Health Care Transactions Through A Common Interface In A Distributed Computing Environment” describes an apparatus and method for processing health care transactions through a common interface in a distributed computing environment using specialized remote procedure calls. The distributed computing environment includes a user interface tier for collecting user inputs and presenting transaction outputs, a data access tier for data storage and retrieval of health care transaction information, a transaction logic tier for applying a predetermined set of transaction procedures to user inputs and health care transaction information resulting in transaction output, an electronic network connecting the user interface tier, data access tier and transaction logic tier to each other and a communication interface for exchanging health care transaction information among the tiers. The communication interface includes an interface definition language generating transaction-specific communication codes whereby data is exchanged through a common interface structure regardless of the origin of the data.

### SUMMARY OF THE INVENTION

The present invention provides a means for an enterprise, such as a health care facility, to transfer preumbra enterprise data from any one of a plurality of disparate, ancillary vendor applications to a requester. The particular strategy used for transferring the preumbra data depends on the type of preumbra data and how that data is formatted in the ancillary preumbra system database. Some ancillary preumbra system databases organize the preumbra data such that very little data processing is necessary by the enterprise application whenever the preumbra is retrieved. Those systems store preumbra data in a manner that is extremely conducive with accessing the preumbra data from the respective ancillary system's database in real-time and therefore can be accessed upon a request being received for the preumbra data. Some other ancillary preumbra systems store preumbra data such that it is impossible to access the requested preumbra data, aggregate it and then prepare it for presentation in near real-time. Additionally, aggregating the preumbra data needed for computing some line items might require accessing multiple preumbra data entries in the ancillary penumbra system's database. The preumbra data stored in those ancillary system databases must be accessed periodically and the preumbra data processed (aggregated) and then stored in a preumbra/enterprise database for subsequent delivery to a user upon receiving a request.

### BRIEF DESCRIPTION OF THE DRAWINGS

The novel features believed characteristic of the invention are set forth in the appended claims. The invention itself, however, as well as an exemplary mode of use, further objectives and advantages thereof, will best be understood by reference to the following detailed description of an illustrative embodiment when read in conjunction with the accompanying drawings, wherein:

The present invention is illustrated by way of example, and not by way of limitation, in the figures of the accompanying drawings and in which like reference numerals indicate similar elements and in which:

FIG. 1 is a diagram of an exemplary HL7 message;

FIG. 2 is a network diagram showing several disparate, ancillary systems depicted as Admissions, Discharge and Transfers (ADT), Radiology, Medical Records/Transcriptions, Pharmacy and Laboratory;

FIG. 3 is a flowchart depicting a process by which a disparate, ancillary system generates a message in response to a trigger event;

FIG. 4 is a diagram of an enterprise network, which utilizes an automated interface gateway for routing level seven (such as HL7) event triggered messages;

FIG. 5 is a diagram of an enterprise system which includes a plurality of disparate, ancillary systems for executing enterprise level message transactions in accordance with an exemplary embodiment of the present invention;

FIG. 6 is an illustration of a screen shot of the enterprise home page for presenting preumbra data;

FIG. 7 is a screen shot of the System Profitability Summary financial statement as presented to the enterprise user;

FIG. 8 is an illustration of a screen shot of employee type preumbra data contained in an employee demographic report;

FIG. 9 is a flow diagram that illustrates how exemplary reports containing preumbra data are connected to one another in accordance with an exemplary embodiment of the present invention;

FIG. 10 pictorially represents the data transfer strategy employed by the PDTM in accordance with an exemplary embodiment of the present invention;

FIG. 11 is a flowchart depicting a process for transferring data from an ancillary preumbra system database to an enterprise system which handles both umbra and preumbra data and is depicted in accordance with an exemplary embodiment of the present invention;

FIG. 12 is a flowchart depicting a lower level of process for handling requests for preumbra data in accordance with the preferred embodiment of the present invention;

FIG. 13 is a flowchart depicting a lower level process for transferring preumbra data from an ancillary preumbra system database to a preumbra/enterprise database in accordance with an exemplary embodiment of the present invention;

FIG. 14 is a flowchart depicting a high-level process and is depicted for other than real time transfers of block data in accordance with an exemplary embodiment of the present invention;

FIG. 15 is a diagram depicting an exemplary employee structure that might be found in a typical enterprise; and

FIG. 16 is a flowchart depicting security flow for financial preumbra data in accordance with an exemplary embodiment of the present invention.

Other features of the present invention will be apparent from the accompanying drawings and from the detailed description that follows.

### DETAILED DESCRIPTION OF THE INVENTION

Migrating to an enterprise level system from a plurality of disparate, ancillary systems is an expensive and time consuming undertaking for an enterprise. Many enterprises refuse to move from antiquated legacy systems to more modern, user friendly managed desktops such as network computing (NC), or the like, until the Total Cost of Ownership (TCO) for maintenance and upkeep on the legacy system exceeds that of TCO for implementing the more modem network. In the case of disparate, ancillary system applications, the TCO factors are even less appealing to the enterprise because oftentimes, the ancillary applications are state of the art, though not enterprise friendly. Additionally, instituting enterprise level infrastructures, including master libraries and data stores, is a daunting task for an enterprise because department IS specialists must be retrained for the enterprise technology. In an effort to alleviate many of the shortcomings described above, standardized message protocols have been promulgated for the transfer of messages between individual disparate, ancillary systems, rather than wholesale migration to enterprise level systems. By adopting standardized messaging protocols and without resorting to expensive enterprise-wide solutions, disparate, ancillary system applications can communicate more effectively and thus, alleviate at least a portion of the limitation of the prior art.

Many of these standardized message protocols utilize the seventh, or top layer, of the protocol stacks known as the Application Layer. Application Layer Seven is the top layer of the many protocol stacks, including the OSI (Open System Interconnection) and TCP/IP (Transmission Control Protocol/Internet Protocol) protocol suites. Generally, an application layer is software that provides the starting point for a communications session. Software programs in the application layer initiate communications between entities, such as applications.

Some of the most widely known application protocols in the TCP/IP suite are FTP (File Transfer Protocol), SMTP (Simple Mail Transfer Protocol), Telnet, DNS (Domain Name System) and WINS (Windows Internet Name System). Other, more special purpose application level protocols also exist. These include the IN (Intelligent Network) and AIN (Advanced Intelligent Network) protocols of the SS7 (Signaling System 7) protocol used in publicly switched telephone systems and the HL7 (Health Level Seven) protocol used in the healthcare industry. With the exception of certain of the TCP/IP's own application protocols, the language and format used in a user's client/server program are not known to a transport or communications protocol and instead, they are known only to the receiving programs that must parse the incoming request to find out what the client is asking for. In many instances, data from the programs at the top layer of a protocol suite are “handed down” to the lower layers in a protocol stack for actual transport processing. Conversely, the data is then “handed up” the protocol stack to the appropriate application in the receiving machine.

With respect to the TCP/IP protocol suite, a program identifies the application it wishes to communicate with by that application's socket (also referred to as a socket address or socket number), which is a combination of (1) the server's IP address and (2) the application's port. If, using the TCP/IP protocol for example, an application does not know the IP address of the destination application, but knows the server by name, the application uses a Domain Name System server (DNS server) to turn the name into the IP address. The port is a logical number assigned to every application. For FTP, SMTP, HTTP and other common applications, there are agreed-upon numbers known as “well-known ports.” For example, HTTP applications (world wide web) are on port 80 therefore, a web server is located by its IP address and port 80. An organization's internal client/server applications are given arbitrary ports for its own purposes.

Generally, protocols are standardized by industry members (application developers, OEMs (Original Equipment Manufacturer) and interested parties, together herein referred to as “vendors”). These vendors form a common interest standards organization that works for harmonizing rules for using the subject protocol. The primary purpose of a standards organization is to attempt to adopt metrics and rules for the use of hardware or software. The rules are sometimes referred to as the specification and using a specification adopted by a standards body is referred to as a de jure use (as opposed to de facto use where the specification is informally adopted by its wide acceptance and use without formal sanctioning). Exemplary standards bodies include ANSI, (American National Standards Institute) and ISO, (The International Organization for Standardization). Rules for application level protocols include language and format standards needed to establish a session. Applications that follow the particular rules established by a standards body are considered compliant with the standard they follow. In the case of an applications layer protocol, it is expected that two compliant applications would be able to establish a communications session because the language and format of the session has been harmonized in advance by the standards body for the application level protocol.

In practice however, the rules set forth by a standards body can be rather loose and may take the form of guidelines rather than rigid rules. Usually loose standards are an outcome of competing marketplace interests, where each vendor jealously supports protocol rules compatible with its own product rather than supporting rules that favor another vendor's products. In its infancy, the standards body often attempted to pacify competing interests within the standards body by adopting looser rules which did not give any individual or group of vendors a strategic advantage in the marketplace. Rather than alienating any major players in the body by adopting standardization rules similar to a competing vendor's product, the standards body also gave individual vendors more discretion to use their own proprietary protocol variants.

Lax, flexible or conflicting standardization rules may result in applications that are compliant with the standard and yet, unable to decipher each other's message structures and/or data definitions. In the case of application layer protocols, the resulting inadequacies may be as severe as the inability of compliant applications to establish a session or as minor as an application not being able to decipher proprietary segments of a message sent from another application.

With regard to the discussion herewithin, a level seven message will be understood by artisans as the atomic unit of data transferred between disparate system applications. Every message is structured as a group of segments in a defined sequence. Most messages are triggered by real world events and every message type defines the purpose of the message. For example, a patient being admitted to a health care enterprise triggers an ADT Message type A01. Below, Table I is a nonexhaustive list containing exemplary HL7 message types and descriptions of the message.

TABLE I
(HL7 Message Types)

| Message | Description |
|---|---|
| ACK | General acknowledgment message |
| ADR | ADT response |
| ADT | ADT message |
| DOC | Document response |
| PIN | Patient insurance information |
| R0R | Pharmacy/treatment order response |
| RAR | Pharmacy/treatment administration information |
| RAS | Pharmacy/treatment administration message |
| RDO | Pharmacy/treatment order message |
| RDR | Pharmacyltreatment dispense information |
| RDS | Pharmacy/treatment dispense message |
| SQM | Schedule query message |
| SQR | Schedule query response |
| SRM | Schedule request message |
| SRR | Scheduled request response |
| SUR | Summary product experience report |
| TBR | Tabular data response |

The ADT type A01 message is from Patient Administration (ADT) triggered by an event (A01) concerning a patient being admitted. The patient admission trigger event causes the ADT application to broadcast the ADT type A01 message to a predefined set of application socket addresses. The message body contains pertinent data describing the event. For the purposes of the description of the present invention, the exemplary discussions will refer to the HL7 messaging protocol adopted by the healthcare industry. The use of the HL7 standard is not meant to limit the scope or use of the present invention and, as ordinary artisans will readily realize, the present invention may be implemented in a variety of protocols adopted by various business enterprises without departing from the scope or intent of the present invention.

HL 7 messages are composed of uniquely identified segments and each uniquely identified message segment is a logical grouping of segment fields. Below, Table II is a nonexhaustive list containing exemplary HL7 segment types and corresponding segment descriptions.

TABLE II
(HL7 Segment Types)

| Segment | Description |
|---|---|
| ACC | Accident segment |
| ADD | Addendum segment |
| AIG | Appointment information - general resource segment |
| AIL | Appointment information - location resource segment |
| AIP | Appointment information - personnel resource segment |
| AIS | Appointment information - service segment |
| AL1 | Patient allergy information segment |
| APR | Appointment preferences segment |
| ARQ | Appointment request segment |
| AUT | Authorization information segment |
| BLG | Billing segment |
| ERR | Error segment |
| EVN | Event type segment |
| FAC | Facility segment |
| FHS | File header segment |
| FT1 | Financial transaction segment |
| LCC | Location charge code segment |
| LCH | Location characteristic segment |
| LDP | Location department segment |
| LOC | Location identification segment |
| LRL | Location relationship segment |
| MFI | Master file identification segment |
| MSA | Message acknowledgment segment |
| MSH | Message header segment |
| PID | Patient identification segment |
| RXA | Pharmacy/treatment administration segment |
| RXC | Pharmacy/treatment component order segment |
| RXD | Pharmacy/treatment dispense segment |
| RXE | Pharmacy/treatment encoded order segment |
| RXG | Pharmacy/treatment give segment |
| RXO | Pharmacy/treatment order segment |
| RXR | Pharmacy/treatment route segment |

Every segment field is associated with a particular data element type and that association depends on the type of unique segment containing the segment field. Below, Table III is a nonexhaustive list containing exemplary HL7 data element types and corresponding specification for the data elements.

TABLE III
(HL7 Data Element Types)

| Element Type/Description | Item # | Seg | Seg # | Len | DT | Rep | Table |
|---|---|---|---|---|---|---|---|
| Accident Code | 00528 | ACC | 2 | 60 | CE | | 0050 |
| Accident Date/Time | 00527 | ACC | 1 | 26 | TS | | |
| Accident Death Indicator | 00814 | ACC | 6 | 12 | ID | | 0136 |
| Accident Job Related Indicator | 00813 | ACC | 5 | 1 | ID | | 0136 |
| Accident Location | 00529 | ACC | 3 | 25 | ST | | |
| Account ID | 00236 | BLG | 3 | 100 | CX | | |
| Account Status | 00171 | PY1 | 41 | 2 | IS | | 0117 |
| Acknowledgment Code | 00018 | MSA | 1 | 2 | ID | | 0008 |
| Admission Type | 00134 | PV1 | 4 | 2 | IS | | 0007 |
| Admit Date/Time | 00174 | PV1 | 44 | 26 | TS | | |
| Admit Reason | 00183 | PV2 | 3 | 60 | CE | | |
| Admit Source | 00144 | PV1 | 14 | 3 | IS | | 0023 |
| Admitting Doctor | 00147 | PV1 | 17 | 60 | XCN | Y | 0010 |
| Assigned Patient Location | 00133 | PY1 | 3 | 80 | PL | | |
| Assigned Patient Location | 00133 | FT1 | 16 | 80 | PL | | |
| Attending Doctor | 00137 | PV1 | 7 | 60 | XCN | Y | 0010 |
| Billing Category | 01007 | PRC | 14 | 60 | CE | Y | 0293 |
| Birth Order | 00128 | PID | 25 | 2 | NM | | |
| Birth Place | 00126 | PID | 23 | 60 | ST | | |
| Business Phone Number | 00195 | NK1 | 6 | 40 | XTN | Y | |
| Consulting Doctor | 00139 | PV1 | 9 | 60 | XCN | Y | 0010 |
| Contact Address | 01166 | FAC | 7 | 200 | XAD | Y | |
| Contact Person | 01266 | FAC | 5 | 60 | XCN | Y | |
| Contact Person Social Security | 00754 | NK1 | 37 | 16 | ST | | |
| Number | | | | | | | |
| Contact Person's Address | 00750 | NK1 | 32 | 106 | XAD | Y | |
| Contact Person's Name | 00748 | NK1 | 30 | 48 | XPN | Y | |
| Contact Person's Name | 00748 | GT1 | 45 | 48 | XPN | Y | |
| Contact Person's Telephone | 00749 | NK1 | 31 | 40 | XTN | Y | |
| Number | | | | | | | |

The first column of Table III identifies a data element by ELEMENT TYPE while the remaining columns define the element's HL7 attributes. ITEM # is an HL7-specific number that uniquely identifies the data element throughout the HL7 standard. SEG is the HL7 identity of any segments that the data element will occur and SEQ defines the ordinal position of the data element within the identified HL7 segment. The column labeled LEN refers to the maximum number of characters that one occurrence of the data element may occupy within the segment. The length of a field is normative; however, in general practice, it is often negotiated on a vendor-specific basis. The column labeled DT refers to restrictions on the contents of the data field. REP defines whether a field may repeat and if so, the maximum number of repetitions permitted. The column labeled TABLE defines a HL7 table of values for a particular data element. A table defines a list of values for the entity. In this case, the data element. Tables may contain either HL7 or user defined values.

Segment types may be required or optional, depending on the message and event types. Segments are identified using a unique segment identifier code (ID). For example, an ADT message may contain Message Header (MSH), Event Type (EVN), Patient ID (PID), and Patient Visit (PV1) segments. Segments may also be proprietary to a vendor and thus identified with segment ID codes beginning with the letter Z.

Each HL7 segment consists of a collection of segment fields, or string of characters. Certain segment fields may be required or merely optional within a particular segment depending on the segment identifier code. Segment fields are transmitted as character strings; however, some HL7 segment fields may take on the null value, which is different from an optionally deleted field. For cases where a value for the data element is transmitted, a segment field may contain a data element or might merely be a placeholder within the segment for that data element. The HL7 Standard specification contains segment attribute tables that list and describe data fields within an identified segment and characteristics of their usage. HL7 fields are defined in a comprehensive data field dictionary.

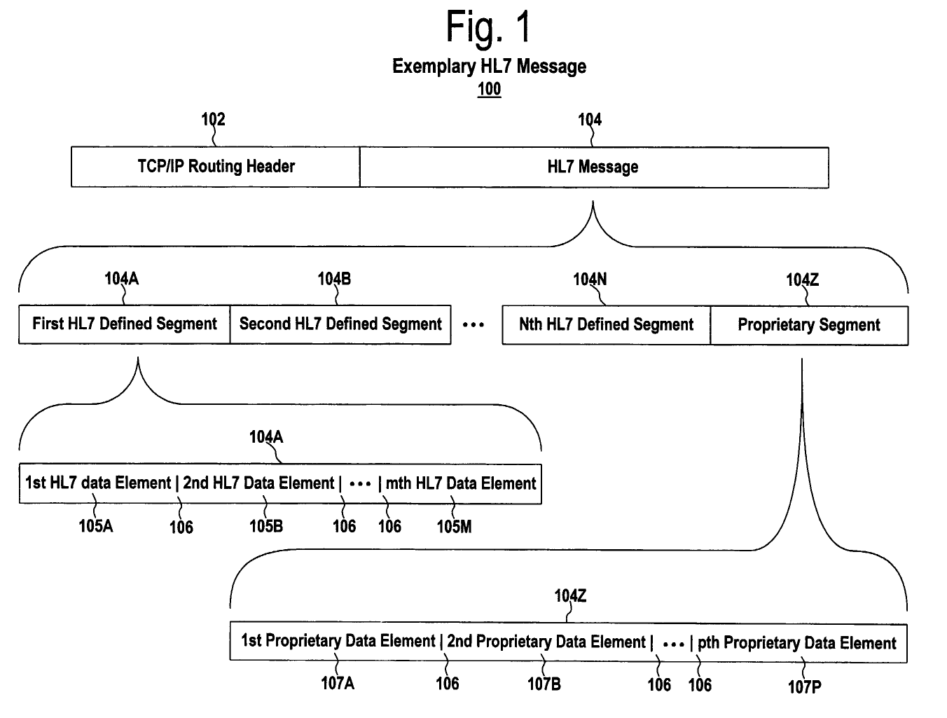

FIG. 1 is a diagram of an exemplary HL7 message 100. A HL7 message is normally generated in response to a trigger event. There are various message types defined in the HL7 message specification for various trigger events. Each message type comprises of segments which, in turn, are built up by different segment fields. The inclusion of the fields in the message segment may be Required (R), Optional (O), or Not Used (N). Below are some exemplary HL7 message types, along with segment descriptions for each message.

1. Message Type: ACK (General Acknowledgement Originator)—It has 3 segments:

(a) MSH—Message Header (R).

(b) MSA—Message Acknowledgement (R).

(c) ERR—Error Message

2. Message Type: ADT (Admission, Discharge and Transfer)—It has various ADT events associated. For example,

ADT Event Code: A01

Event: ADMIT A PATIENT

Message Segments are:

(a) MSH—Message Header (R).

(b) EVN—Event Type (R).

(c) PID—Patient Identification (R).

(d) NK1—Next of Kin (R).

(e) PV1—Patient Visit (R).

(f) DG1—Diagnosis Information (O).

ADT Event Code: A02

Event: TRANSFER A PATIENT

Message Segments are:

(a) MSH—Message Header (R).

(b) EVN—Event Type (R).

(c) PID—Patient Identification (R).

(d) PV1—Patient Visit (R).

ADT Event Code: A03

Event: DISCHARGE A PATIENT

Message Segments are:

(a) MSH—Message Header (R).

(b) EVN—Event Type (R).

(c) PID—Patient Identification (R).

(d) PV1—Patient Visit (R).

The PID (Patient Identification) segment is used by all ancillary systems' applications as the primary means of communicating patient identification information. This segment contains permanent patient identifying and demographic information that, for the most part, is not likely to change frequently. Therefore, the PID segment must contain non-ambiguous information values that are easily understood across disparate systems. Below is an exemplary table containing segment attributes for a PID segment.

TABLE IV
(PID Segment Attributes)

| Seq | Len | DT | Opt | Rep | Table | Item # | Element Type |
|---|---|---|---|---|---|---|---|
| 1 | 4 | SI | O | | | 00104 | Set ID - PID |
| 2 | 20 | CX | B | | | 00105 | Patient ID |
| 3 | 20 | CX | R | Y | | 00106 | Patient Identifier |
| | | | | | | | List |
| 4 | 20 | CX | B | Y | | 00107 | Alternate Patient |
| | | | | | | | ID - PID |
| 5 | 48 | XPN | R | Y | | 00108 | Patient Name |
| 6 | 48 | XPN | O | Y | | 00109 | Mother's Maiden |
| | | | | | | | Name |
| 7 | 26 | TS | O | | | 00110 | Date/Time of Birth |
| 8 | 1 | IS | O | | 0001 | 00111 | Sex |
| 9 | 48 | XPN | O | Y | | 00112 | Patient Alias |
| 10 | 80 | CE | O | Y | 0005 | 00113 | Race |
| 11 | 106 | XAD | O | Y | | 00114 | Patient Address |
| 12 | 4 | IS | B | | 0289 | 00115 | County Code |
| 13 | 40 | XTN | O | Y | | 00116 | Phone Number- |
| | | | | | | | Home |
| 14 | 40 | XTN | O | Y | | 00117 | Phone Number- |
| | | | | | | | Business |
| 15 | 60 | CE | O | | 0296 | 00118 | Primary Language |
| 16 | 80 | CE | O | | 0002 | 00119 | Marital Status |
| 17 | 80 | CE | O | | 0006 | 00120 | Religion |
| 18 | 20 | CX | O | | | 00121 | Patient Account |
| | | | | | | | Number |
| 19 | 16 | ST | B | | | 00122 | SSN Number- |
| | | | | | | | Patient |
| 20 | 25 | DLN | O | | | 00123 | Driver's License |
| | | | | | | | Number-Patient |
| 21 | 20 | CX | O | Y | | 00124 | Mother's Identifier |
| 22 | 80 | CE | O | Y | 0189 | 00125 | Ethnic Group |
| 23 | 60 | ST | O | | | 00126 | Birth Place |
| 24 | 1 | ID | O | | 0136 | 00127 | Multiple Birth |
| | | | | | | | Indicator |
| 25 | 2 | NM | O | | | 00128 | Birth Order |
| 26 | 80 | CE | O | Y | 0171 | 00129 | Citizenship |
| 27 | 60 | CE | O | | 0172 | 00130 | Veterans Military |
| | | | | | | | Status |
| 28 | 80 | CE | O | | 0212 | 00739 | Nationality |
| 29 | 26 | TS | O | | | 00740 | Patient Death |
| | | | | | | | Date and Time |
| 30 | 1 | ID | O | | 0136 | 00741 | Patient Death |
| | | | | | | | Indicator |

The PID Segment Attribute Table IV is similar to Table III (HL7 Data Element Types) described above with the additional column labeled OPT that defines whether or not a particular field is required (R), optional (O), conditional in a segment (C), not used with a trigger event (X) or left in for backward compatibility for other HL7 versions (B). Using the above-described HL7 rules, any disparate application can generate an HL7 message. Below is an example of an HL7 admit/visit notification transaction triggered from an A01 event (admitted patient).

MSH|ˆ ˜\&|ADT1|SWR|LABADT|SWR|198808181126|SECURITY|ADTˆ A 01|MSG00001|P|2.3.1|<cr>

EVN|A01|200101030803∥<cr>

PID|1∥PATID1234ˆ 5ˆ M11ˆ ADT1ˆ MRˆ SWR˜123456789ˆ ˆ ˆ USSSAˆ SS∥JOHNSONˆ DARRELLˆ A∥19610615|M∥C|1200 N ELM STREETˆ ˆ GREENSBOROˆ NCˆ 27401-1020|GL|(919)379-1212|(919)271-3434∥S∥

PATID12345001ˆ 2ˆ M10ˆ ADT1ˆ ANˆ A|123456789|987654ˆ NC|<cr>

NK1|1|JONESˆ BARBARAˆ K|WIˆ WIFE∥∥NKˆ NEXT OF KIN<cr>

PV1|1|I|7050ˆ 7113ˆ 01∥∥101010ˆ SHYNERˆ RALPHˆ J.|∥SUR∥∥ADM|A0|<cr>

Patient Darrel A. Johnson was admitted on Jan. 3, 2001 at 08:03 a.m. by doctor Ralph J. Shyner (#101010) for surgery (SUR). He has been assigned to room 7113, bed 01 on nursing unit 7050. The message was sent from system ADT1 at the SWR site to system LABADT, also at the SWR site, on the same date as the admission took place, but three minutes after the admit. Returning to FIG. 1, HL7 message 100 is composed of at least two parts, TCP/IP routing header 102 and HL7 message 104. The structure of TCP/IP routing header 102 is well known and will not be discussed further except to note that TCP/IP routing header 102 contains routing information necessary to transmit message 100 from a source application to a destination application. The sources and destination are both identified in packet 100's header.

HL7 message 104, on the other hand, is defined by rules set forth in the HL7 specification and those rules must be observed for a message generated by one disparate, ancillary system to be understood by a second disparate, ancillary system. In general, HL7 message 104 is comprised of a series of uniquely identified message segments which serve a purpose according to the message type, segments 104A-104N and 104Z are shown in FIG. 1. Segments 104A-104N contain information arranged and formatted in accordance with HL7 segment attribute rules. Each of the N segments contains a predetermined number for segment fields for holding a sequence of HL7 defined data elements.

Proprietary segment 104Z differs from HL7 defined segments 104A-104N in that the data element values contained within segment 104Z may be vendor-specific. This data may be defined and implemented by individual application vendors without regard to the HL7 specification. Often, vendors will utilize proprietary segments when the standardized definitions are ambiguous or significant errors have been encountered by attempting to follow message protocol standards. As discussed above, proprietary segment 104Z is uniquely identified as such and may be disregarded by disparate systems which are not privy to the vendor's proprietary segment specification.

Within each of the segments 104A-104N and 104Z, are a series of defined data elements. Segment 104A is shown as having M number of HL7 defined data elements in fields 105A-105M. Each of the fields 105A-105M is delimited by field separator 106 (although not shown in FIG. 1 segment boundaries are also delimited by segment terminators). Each data element occupies a predefined segment field that is defined by field delimiters. Therefore, by utilizing the HL7 definition for a particular segment type, the segment field associated with a particular data element may be found in HL7 message 100 using a three-step process. First, it identifies the message type and derives the segment and element types for that message. Next, it identifies a segment containing the value of a data element. Finally, it finds the segment field that holds the data element by counting delimiters.

Proprietary segment 104P may also be comprised of a series of data items separated by delimiters. FIG. 1 depicts proprietary segment 104Z as having words 107A-107P, each word separated with the segment by delimiters 106. However, in contrast with HL7 defined segments 104A-104N, proprietary segment 104Z may consist of P vender-defined proprietary words 107A-107P that are arranged within proprietary segment 104Z according to a vendor-defined specification. Therefore, even if the element type definitions of data element 107A-107P comply with the HL7 protocol, accessing the values for these elements in a message is nearly impossible without using the vendor's specification that defines the segment fields that hold each data element.

Generally, it is expected that each of the segments 104A-104N contain uniquely defined data elements, arranged in a predetermined sequence. Therefore, in any HL7 compliant message, it should be possible to identify where the segment data element resides without reading every data element in each segment. Thus, a receiving application can expedite the retrieval and essential data value by merely accessing the particular segment in message 100 that holds the essential data element. By merely counting field separators, the application can forgo reading any data value located in segment fields that are not essential to the message. Conversely, a sending application may omit entering data element values in any segment field that the application does not consider essential to the message. However, as alluded to above, data type definitions are often ambiguous, making the association between a particular data type and a particular data field and segment less sure and more dependent on vendor specifications.

Yet another issue is when you receive a standard HL7 revision record. As an example, the patient Darrel Johnson is moved from bed 01 on nursing unit 7050 to bed 04 in nursing unit 6050. Some vendors will send a complete HL7 revision record with all patient data including the new room and bed data. Yet another vendor will send only the “change” data elements and omit the “unchanged” elements. Since the record received for processing is, by definition, a “revision” record, one has to wonder if the omitted data elements infer that the omitted data element should be “blanked out”, deleted or “nulled” in the enterprise database. Depending on the vendor, some blank data elements in the received HL7 revision record should be ignored and the enterprise database should retain any previous data elements. In yet another vendor's revision record processing, the blank data field will signify that the original data entry person(s) intended to “remove” ambiguous data from the enterprise database and should therefore be processed in the enterprise database accordingly. Here, applying the vendor supplied processing rules to incoming HL7 records becomes very important to the integrity of the enterprise database.

Fundamental to the success of any standard messaging protocol is the ability for disparate, ancillary systems to understand message content generated by and received from other systems. Messaging protocols must standardize data elements and attribute definitions by providing unambiguous definitions for every data element and attribute. Definitions that are too broad breed confusion in a message body as vendors will invariably use different entry fields for identical data values. When implementing a messaging protocol, care must be taken to avoid confusion between vendors of disparate, ancillary system applications. Initially, vendors must agree to a standardized protocol. Once the protocol has been decided, an auxiliary specification must be established between vendors that specify additional trigger events and message types that identify optional values to be used within the protocol's specification and clarifies perceived ambiguities between vendors.

With regard to prior art medical ISS technologies, individual medical departments contracted for, and implemented their own ISS solutions without regard to the needs of the enterprise as a whole or the needs of other departments within the enterprise. ISS integration and compatibility was not a concern. Data entry, information storage and data retrieval was performed by the individual departments. However, an individual user had to be authorized on the disparate, ancillary application systems and use application interfaces from the individual applications. The individual applications did not interface with each other unless the applications were products by the same vendor.

The result, for whatever reason, is an industry supported by multiple vendors, each sponsoring its own ancillary system applications, which are incorporated in an enterprise's ISS. From an enterprise level perspective, most ISS assimilation appears to be on an ad hoc basis. More importantly, due to the ad hoc assimilation and structuring of ISS systems, it is impossible for a user to get a coherent view of enterprise level data from the ancillary systems. A user needing data, most generally, must be authorized by an ancillary department and then access the disparate, ancillary system that is responsible for acquiring that particular data for that department. With such a system in place, it is virtually impossible for a user to understand enterprise relationships between the data stored in disparate, ancillary systems. Still more exacerbating, a user must gain a certain amount of proficiency in every system in order to effectively drill down into an ancillary database to needed data. It is utterly impossible for a non-ISS user, such as a manager, engineer, nurse, doctor, specialist, etc., to gain that level of proficiency in the normal course of business.

After several departments obtain their needed ISS systems, those departments soon realize the need to communicate with each other. If, by chance, the vendor applications are compatible or compliant with a standard, the disparate, ancillary application may communicate. If, as is more likely, the disparate vendor applications are not compatible or not compliant or the standards are weak, then the disparate applications may not communicate in a meaningful way.

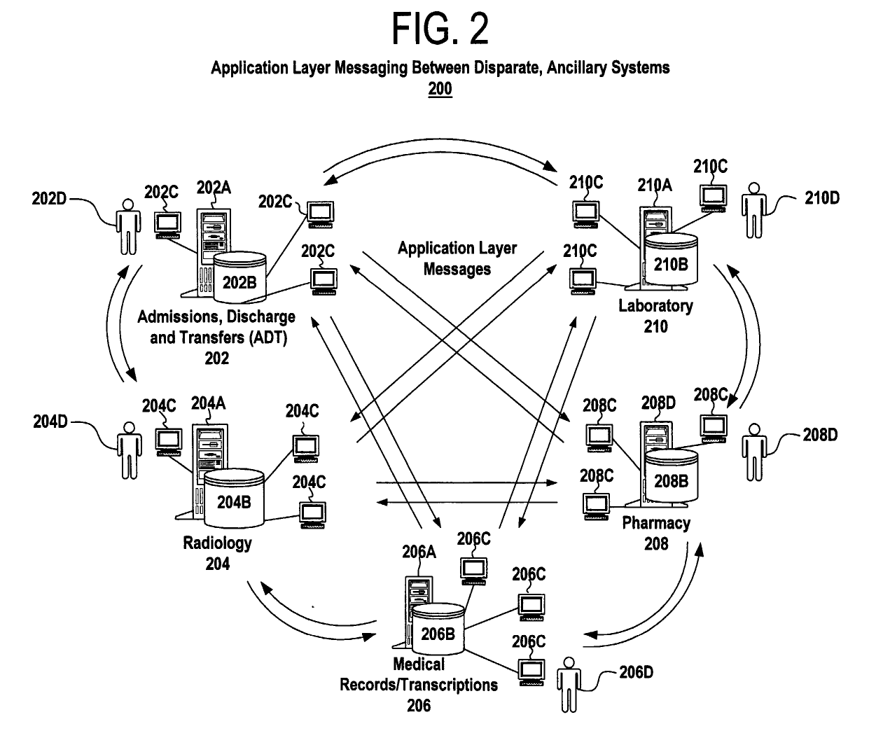

Communication between ancillary systems may take a number of forms, but for the purpose herein, the communications process occurs as depicted in FIG. 2. FIG. 2 shows several disparate, ancillary systems depicted as Admissions, Discharge and Transfers (ADT) 202, Radiology 204, Medical records/transcriptions 206, Pharmacy 208 and Laboratory 210. The depicted systems are merely illustrative of the disparate, ancillary systems that may be present within a health care enterprise and one of ordinary skill in the art would readily realize that other systems may be present in combination or in place of the exemplary systems. Each of the respective disparate, ancillary systems utilize servers 202A, 204A, 206A, 208A and 210A for processing information to and from their respective terminals 202C, 204C, 206C, 208C and 210C and storage units 202B, 204B, 206B, 208B and 210B. It is expected that any one users 202D, 204D, 206D, 208D and 210D initiate a trigger event by communicating with their respective servers 202A, 204A, 206A, 208A and 210A via respective terminals 202C, 204C, 206C, 208C and 210C.

The occurrence of the real world event triggers a message, in this case a HL7 compliant message, being sent. Message transactions are represented by arrows to and from each of the disparate, ancillary systems 202, 204, 206, 208 and 210 which are functionally connected to one another over a network such as a Local Area Network (LAN) or possibly a Wide Area Network (WAN). As discussed above, a trigger event causes information associated with the event to be sent to one or more ancillary systems. Many types of HL7 messages are generated in response to a trigger event. As such, the transaction is termed an “unsolicited update”. Ancillary applications that need event information from a trigger event must listen for a message containing the unsolicited update information values.

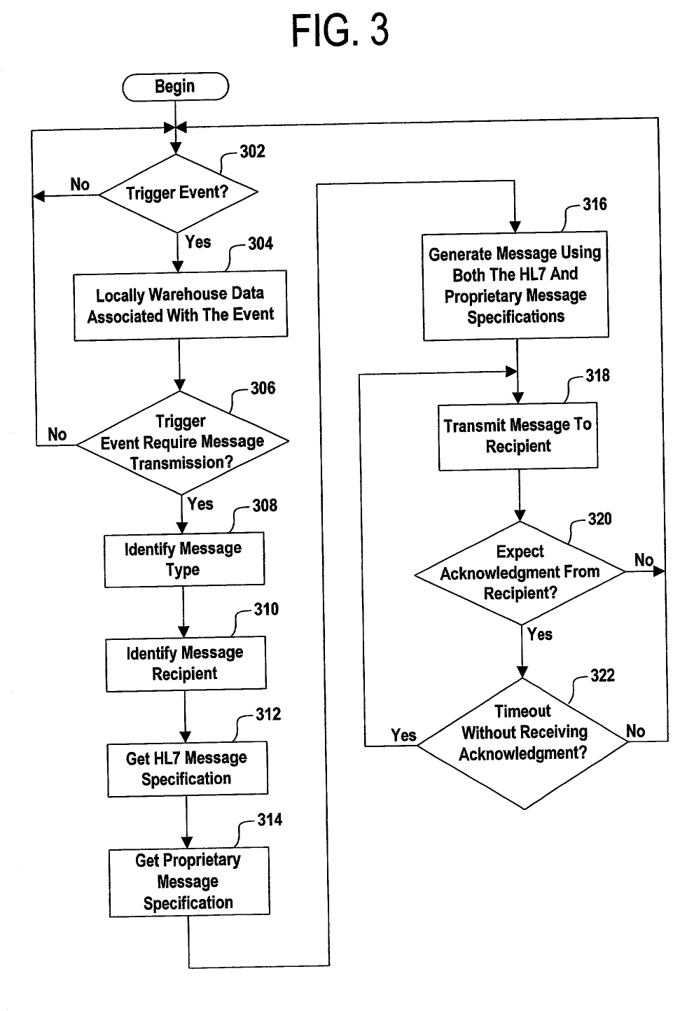

The process by which a disparate, ancillary system handles message generation using a standardizing messaging protocol in response to a trigger event is depicted in FIG. 3. Initially, each of disparate, ancillary systems 202, 204, 206, 208 and 210 are in a ready state waiting for the occurrence of a trigger event (step 302). Once a trigger event is detected, the event is immediately identified and the event information is processed and stored locally in accordance with vendor-specific rules (step 304). Next, the disparate, ancillary system processing the event determines whether to generate a HL7 compliant message with the event information (step 306). If a message is not to be generated, the system returns to the ready state and the process returns to step 302. If a compliant message is to be sent to another ancillary system, then the application processing the event information must first identify the appropriate HL7 message type by the event type (step 308). Once the message type has been identified, the event processing application identifies all disparate, ancillary systems that are to be sent the message. The systems are identified by their applications' socket addresses (step 310). Here, the event processing application usually looks up the recipient socket numbers associated with an event type. Of course, it is the responsibility of ancillary systems that need event information to provide the ancillary application that processes that event information with their socket address. Next, the message must be formatted in accordance with the HL7 messaging specification (of course, any messaging protocol might be equally applicable) thus, the messaging specification must be accessed (step 312).

It should now be understood that even though a standardized messaging specification has been implemented across disparate, ancillary systems in an enterprise, an auxiliary specification is often necessary to handle ambiguities, harmonize definitions and specify options, usually between at least two disparate vendor applications. Therefore, after the messaging specification has been accessed, the event processing application then accesses an auxiliary (or its proprietary) messaging specification (step 314). While the auxiliary messaging specification may be a vendor-specific specification intended for use only with vendor supplied systems, it is more likely that the proprietary messaging specification is an auxiliary specification compiled by vendors whose applications support an enterprise. Although rare, it is possible that a particular trigger event might mandate the generation of multiple messages, each message being generated in accordance with a recipient-specific specification. However, it is more likely the processing application would use a single auxiliary specification for message generation. A recipient application would then be responsible for accessing the correct proprietary specification for sending and deciphering incoming messages from the sender using the sender's specification.

One or more messages are then generated using both the standard messaging specification and the propriety specification (step 316). The messages are transmitted to the recipient applications' socket addresses (step 318). The processing application may or may not receive an ACK (acknowledgment) message from the recipients. If a recipient application is so configured, it may acknowledge the message by sending an ACK message to the processing application and even provide an error log in a message error segment. Therefore, a processing application may retain instances of transmitted messages in case one or more of the messages must be retransmitted. Therefore, the processing application determines whether or not to expect an ACK message from a recipient (step 320). If an ACK message is not expected, the ancillary system concludes processing of the current trigger event and the process returns to step 302 where the event processing system returns to the ready state. However, if the processing application identifies a recipient application that is configured to acknowledge the event message, the process monitors the time since transmission of the event message (step 322). If the processing application receives an ACK message within a preset time period, the process ends. If not, the process reverts to step 318 where another instance of the message is retransmitted to the recipient application and the time period restarts. The event processing application cannot end the current messaging process until the acknowledgement has been received from the recipient system (at least not without several attempts to communicate with the recipient). If a predetermined number of messages have been sent to the recipient without an acknowledgement, it must be assumed that the recipient system is not listening or cannot respond. In that case, the process ends without an acknowledgment and the process returns to step 302 with the processing system returning to the ready state.

With respect to the description above, as an ancillary application receives a triggering event, that application sends an unsolicited message to one or more system based socket numbers associated with the event type. If an ancillary system is listening at that socket, it will pick up the message and attempt to process it. However, a considerable number of problems may occur between ancillary systems that are attempting to communicate event information. For example, a recipient application might not be listening or may fail to understand the data in the message. Alternatively, the socket number used by the event processing application may not define a valid destination application. Because the event processing application may know the recipient application by a socket number only, the event processing application assumes that the recipient receives every event message. Still, other problems occur when the recipient application attempts to process the message in a manner that is inconsistent with the processing application's messaging specification.

The prior art has attempted to solve many of these problems by employing a myriad of intrusive solutions. Most solutions were based on the premise that no assumption could be made about the design or architecture of either the sending or receiving application. Thus, the easiest solution required that vendors communicate with each other and define rules for handling ambiguities, harmonizing definitions, specifying options and reassigning conflicting port numbers used to link incoming data to the correct applications. These solutions required each vendor to keep abreast of its competitor's technology by relying on disclosures from the competition.

A second tact was to strengthen the standards. To that end, messaging standards were introduced which required that an original mode acknowledgment be returned whenever an unsolicited update was received. By requiring each ancillary application to respond to an event message with an acknowledgment message, the burden of “listening” was more evenly divided between sending applications and receiving applications. A sending application could no longer “send and forget” an event message but instead, was required to retransmit the event message if an acknowledgment was not forthcoming from the recipient system. On the other hand, recipient systems were relieved of the consequences of the network faults occurring between their socket and the sender system. Utilization of the acknowledgment message also relieved a recipient of the responsibility of listening. Transitory lapses in listening were tolerated because the sending system was required to retransmit event messages that were not acknowledged by a recipient system. Other improvements were also employed to ensure that the recipient understood the information contained in an event message. Standards bodies attempted to harmonize definitions and remove ambiguities wherever a consensus of members agreed. Rules that were previously optional were made mandatory. New, more generic open standard text languages were implemented including XML (eXtensible Markup Language). Often, however, the standard's strengthening and harmonization efforts were no more successful than previous efforts that produced weak, guideline-like standards rules.

A third effort came by way of relieving individual vendors of the responsibility for the monitoring of each other's application system changes. The introduction of the Automated Interface Gateway (AIG pronounced “egg”) to intercept and reroute messages between ancillary system applications was directed to that end. AIGs, or interface engines, are generally data integration tools that allow information in the form of messages, records, or transactions to be exchanged, routed, and translated between dissimilar systems and applications. The Integrator and Cloverleaf are examples of interface engines and available from Healthcare.com, Inc., 15301 Dallas Parkway, Dallas, Tex. 75248-4605.

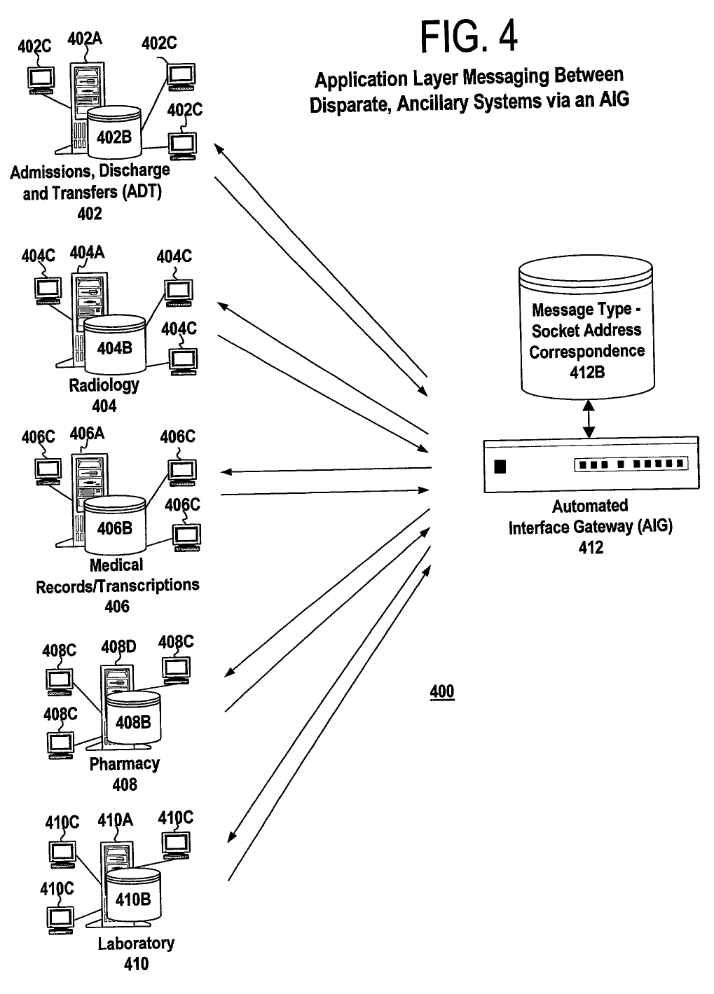

FIG. 4 is a functional diagram of an enterprise network which utilizes an automated interface gateway for routing level seven event triggered messages. FIG. 4 depicts enterprise network 400 that comprises several disparate, ancillary systems each functionally connected to an Automated Interface Gateway (AIG). Admissions, Discharge and Transfers (ADT) 402, Radiology 404, Medical records/transcriptions 406, Pharmacy 408 and Laboratory 410 are identical to disparate, ancillary systems depicted above with respect to FIG. 2. Again, the depicted systems are merely illustrative of disparate, ancillary systems which may be present within a health care enterprise and one of ordinary skill in the art would readily realize that other systems may be present in combination or in place of the exemplary systems. As discussed with respect to FIG. 2 above, each of the respective disparate, ancillary systems utilize servers 402A, 404A, 406A, 408A and 410A for processing information to and from their respective terminals 402C, 404C, 406C, 408C and 410C and storage units 402B, 404B, 406B, 408B and 410B. However, unlike the disparate, ancillary systems depicted in FIG. 2, whenever any one of servers 402A, 404A, 406A, 408A and 410A generate a HL7 compliant message, the message is directed AIG 412 rather than sending the message to a recipient system based on the event type. Message transactions are represented by arrows to and from each of the disparate, ancillary systems 402, 404, 406, 408, 410 and AIG 412.

Including addressability, utilizing an AIG for routing messages between systems has several immediate benefits over system-to-system messaging. When an enterprise configures an AIG in its network, all event messages are initially addressed to the AIG socket rather than to the individual ancillary applications. Thus, an event processing application is freed from maintaining a correspondence table of application socket addresses and event types. Any message generated as result of an event is transmitted to the AIG. The AIG also handles responses, such as ACK messages, thereby freeing resources in the event processing application for other tasks immediately after the AIG receives the event message. Also, with an AIG in place, the event processing application need only send a single event message in response to any trigger event, thereby freeing even more system resources.

By maintaining a comprehensive list of message/event type correspondence tables for all application sockets registered in the enterprise, AIG 412 relives individual vendor applications from the burden of maintaining an extensive list of event (message) type socket addresses. Regardless of the event type, the processing application merely routes the event message to the AIG. Upon receipt by AIG 412, the event processing application (sending system) is identified and the message address layer (TCP/IP layer) is stripped away. AIG 412 then identifies the message and event types from the message header segment (MSH) and the event type segment (EVN), respectively. Using the message/event type information, AIG 412 looks up corresponding recipient application socket addresses using a message/event type socket address correspondence table stored in AIG database 412B. The original HL7 event message body is then repackaged in event messages with the respective recipient application socket addresses. The repackaged event messages are then sent to the respective recipient applications over enterprise network 400. After the event messages are sent, AIG 412 assumes the responsibility for retransmitting any undelivered HL7 event messages to any recipient applications not responding with an ACK message within a preset time period.

The description above provides a greatly simplified view of the workings of a messaging interface engine. It is understood, however, that every vendor relies on the AIG for routing event messages to and from its ancillary applications in an enterprise. In order to assure receiving critical event messages, each vendor is therefore behooved to expeditiously update the AIG database with internal vendor specification changes, updated socket addresses, etc. However, even though the AIG greatly increases messaging reliability between disparate, ancillary systems in an enterprise, many of the shortcomings inherent in the prior art still exist. For instance, ambiguities, optional parameters and outright contradictions in the HL7 specification still necessitate each vendor maintaining auxiliary specifications for all other vendor applications in the enterprise. Even in enterprises where event data is freely and accurately transmitted between ancillary applications, the event data is still stored and maintained at a system level. An enterprise level view of data stored in the respective ancillary databases is impossible because each database maintains only a system level image of its data. Attempts to piece together an enterprise level answer from the ancillary system's present enterprise network 400 is extremely difficult because each ancillary system maintains separate database rules for structuring, storing and interfacing its respective data. Enterprise users not only have to be familiar with the specific data elements stored in disparate system's database, but the user also must maintain the proficiency necessary on that system's interface to drill down into a particular database and acquire the data.

In response to many of the additional shortcomings of the prior art, the enterprise network was further modified to restructure system level HL7 message data to an enterprise standard. Event data processed at a system level can, therefore, be stored and retrieved in an enterprise database. While the prior art teaches storing and retrieving event data to and from a master enterprise database heretofore, the preferred method was to migrate each of the disparate, ancillary applications to an enterprise application and disband the ancillary systems altogether. Individual enterprise departments gave up their ancillary systems for an enterprise system. Department ISS personnel, who once specialized on the ancillary system applications and databases, are absorbed, as needed, into an enterprise ISS. While the wholesale migration of system level applications and databases to an enterprise solution may provide the most expedient path to enterprise level IS answers, the path is fraught with expense and disruption for the enterprise.

An alternative to migrating to a system wide enterprise solution is to layer an enterprise level solution over the existing system level application structure. The AIG interface provides a ready port for connecting to an enterprise level database for storing event data that is organized based on enterprise level information priori rather than the individual system level information structures. Event messages broadcast from the AIG may be transmitted, simultaneously, to a system/enterprise interface engine. This interface engine converts HL7 compliant messages to an enterprise message capable of being processed by an enterprise server. The enterprise server then, among other functions, warehouses the event data, that was converted from HL7 messages, in an enterprise database. The functionality of the individual ancillary system applications remains unmodified and each ancillary system continues to process event information and stores the information locally as described above. With this improvement, the enterprise server processes transactions directly from the enterprise user. Additionally, event information is available to the enterprise server from an enterprise level data stored in the enterprise database. Thus, it is no longer necessary for the enterprise user to drill down into ancillary databases using ancillary system tools.

Briefly, the message/event type socket address correspondence table stored in AIG database is updated with an additional socket address for the system/enterprise interface engine, known as the AIG catcher. The AIG catcher receives and opens HL7 event messages from the AIG and accesses the message body. Each data value in the message body is then mapped to a corresponding enterprise value in an enterprise message body. Once an HL7 message's event data is converted from its original, vendor-specific variant of the HL7 protocol into enterprise structured data, the enterprise message is passed to an enterprise server, where it is processed and written into an enterprise database. Rather than being system specific, as are the ancillary system databases, the enterprise database is enterprise specific. Therefore, in addition to processing any requested transactions, whenever an enterprise message arrives at the enterprise server, the server can autonomously process a variety of additional enterprise transactions related to either the message data or the requested transaction. Processing these related transactions might require that the enterprise server retrieve additional enterprise data from the enterprise database. Access to enterprise level data stored in the enterprise database is further provided to authorized web appliances connected to a web server that is also connected to the enterprise server.

Heretofore, the prior art disparate, ancillary systems were fashioned such that each system's applications relied only on its own internal data. Other than event data received in an HL7 message from another system, applications could not establish functional relationships with data in another application's database. In accordance with an exemplary embodiment of the present invention, the enterprise server establishes functional relationships between seemly disparate event elements. These functional relationships could not be recognized by prior art systems as they processed event data at a system level.

An example of a functional relationship heretofore unrecognized by the prior art involves the occurrence of a trigger event, such as a medical practitioner prescribing a course of respiratory therapy for the patient on an ancillary system, the Medical Records system. Normally, in a prior art enterprise, the physician's order is transcribed by Medical Records' personnel and then the patient's whereabouts are determined by accessing the ADT database. A hard copy of the physician's order is then routed to the nurses' station responsible for monitoring the patient's hospital room. Once the hard copy is received at the nurses' station, a nurse looks up the name and notification information for the respiratory care therapist responsible for the patient's room. The nurse attempts to contact the therapist, usually by telephonic paging. Eventually, the therapist gets the message and attempts to confirm with the nurse by telephone. Scheduling a therapist may take several iterations of paging attempts and return telephone calls. The physician's order also triggers an HL7 message for Patient Billing, ADT, etc. In contrast to the prior art and in accordance with the present invention, a physician's scheduling order for a course of respiratory therapy is received by the enterprise server as an enterprise message, e.g. a request for service. The enterprise application accesses patient information, respiratory therapy duty roster and therapist notification information from the enterprise database. Next, prior to actually processing the physician's service order transaction, the server application locates the patient's assigned floor, room and bed and identifies the therapist and nurses' station assigned to cover the patient's room and bed. The enterprise application notifies both the appropriate therapist and nurses' station of the pending order and only then does the enterprise application process the physician's service order transaction. The physician's service order transaction is supplemented with information acquired by processing the related transactions, such as the patient's location, therapist identity and nurses' station.

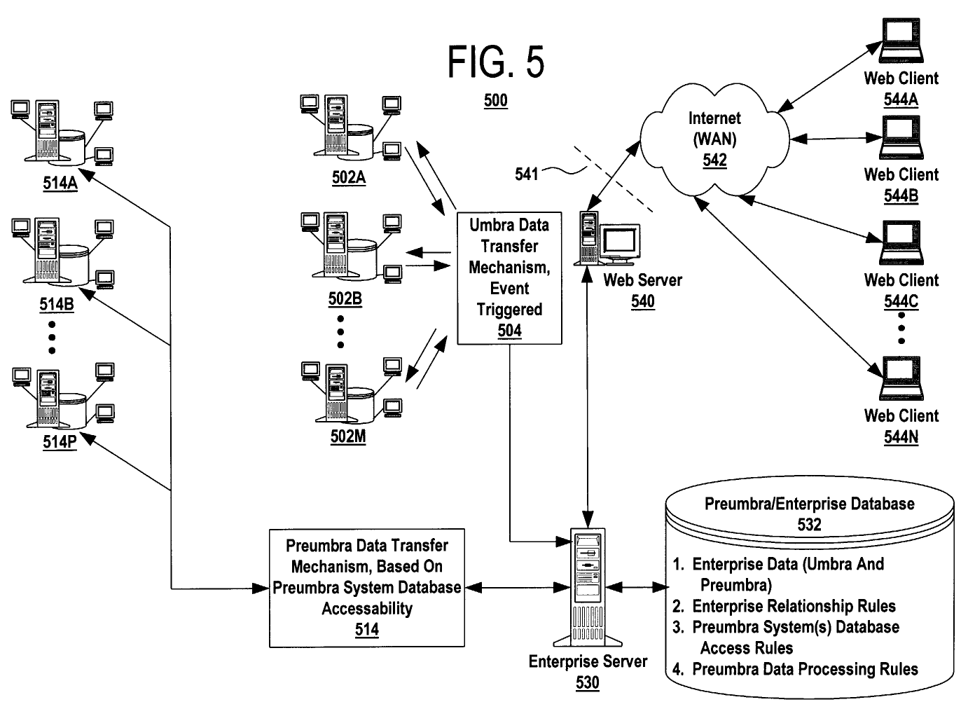

With respect to FIG. 5, a diagram of an enterprise system, including a plurality of disparate, ancillary systems, is depicted for processing enterprise message transactions in accordance with an exemplary embodiment of the present invention. An enterprise message, in accordance with an exemplary embodiment of the present invention, is compliant with proprietary enterprise messaging standards with respect to an enterprise messaging standard or specification. These standards are derived by the enterprise in furtherance of a defined enterprise information priori. In one exemplary embodiment, the enterprise messaging specification is similar, and in fact, based on the HL7 framework. In other embodiments, the enterprise messaging specification is based on a vendor's messaging framework of an existing enterprise system. Using this second messaging framework positions the enterprise for deferred, but eventual, migration of each of the disparate, ancillary systems to an enterprise system.

Although and in accordance with the depiction shown in FIG. 5, the network elements are shown as physical network elements. In practice, certain network elements are actually logical sub-components of other physical network elements. For example, Umbra Data Transfer Mechanism 504 is depicted as a unique physical structure with its own storage, vendor specific mapping tables, that is separate and apart from enterprise server 530. However, in practice, the functionality of Umbra Data Transfer Mechanism 504 (UDTM) is contained within enterprise server 530 and the information on vendor specific mapping tables 532 is actually stored on enterprise database 532. UDTM 504 is described in co-pending application titled “Method And System For Assimilating Data From Disparate, Ancillary Systems Onto An Enterprise System,” attorney docket number 017017-620002, and is hereby incorporated by reference in its entirety and therefore will not be described in elaborate detail herein.

In general though, UDTM 504 is a data transfer layer which is operationally connected to existing ancillary, umbra systems 520A-502M for intercepting existing messages and populating the umbra data portion of preumbra/enterprise database 532. In one embodiment, UDTM 504 utilized an existing messaging protocol, the HL7 protocol, for effecting that transfer of umbra data from the HL7 messages to the enterprise system.

Similarly, enterprise network 500 also contains Preumbra Data Transfer Mechanism 514 (PDTM) operationally connected between each of ancillary preumbra systems 514A-514P and enterprise server 530. However, in contrast with UDTM 504, PDTM 514 cannot take advantage of an existing messaging protocol because usually, the data transfer mechanism of choice is hard copy reports or emailed soft copies. Thus, the messaging protocol necessary is not usually implemented. Normally, preumbra data is accumulated, aggregated and stored in its originating ancillary preumbra system independent from all other ancillary systems. Thus, in further contrast with operation of UDTM 504, prior art enterprise networks rarely took advantage of the proprietary segment feature of the HL7 standard because administrators usually could not justify writing an auxiliary messaging specification for HL7 for preumbra data. There simply was not the pressing need for near real-time access to preumbra data thus, the administrators relied on the distribution of hard copy reports to the various enterprise departments. Of course, the preumbra data present in those reports was presented at the same system level perspective that plagued the prior art with respect to the umbra data presentations.

Moreover, PDTM 514 is flexible enough to access preumbra data from different ancillary preumbra systems using different data transfer methods. This flexibility is necessary due to the wide variance in preumbra data storage formats being employed on the different vendor's systems, for different preumbra data types. For example, some ancillary preumbra system databases store preumbra data in a manner that is extremely conducive with accessing the preumbra data from the respective ancillary system's database in real-time. In those systems' databases, the preumbra data is organized such that very little data processing is necessary by the enterprise application. At the other extreme, some ancillary preumbra systems store preumbra data such that it is impossible to access the requested preumbra data, aggregate it and then prepare it for presentation in near real-time. Additionally, aggregating the preumbra data needed for computing some line items might require accessing multiple preumbra data entries in the ancillary penumbra system's database. The amount of time necessary for generating a value for that line item is correspondingly increased. Furthermore, aggregating a massive amount of preumbra data requires massively more time than aggregating just a few preumbra data values. The operation of PDTM 514 will be described in more detail in the following figures.

At the center of the enterprise system is enterprise server 530 which supports an enterprise application. Enterprise server 530 may be, for example, an IBM RISC/System 6000 system, a product of International Business Machines Corporation in Armonk, N.Y., running the Advanced Interactive Executive (AIX) operating system or alternatively could include an Intel based Symmetric MultiProcessing (SMP) server such as available from Dell Computer Corporation, One Dell Way, Round Rock, Tex. 78682 and Compaq Computer Corp., 20555 SH 249, Houston, Tex. 77070, etc. running Microsoft Windows NT operating system (Windows NT a trademark of and available from Microsoft Corporation, One Microsoft Way, Redmond, Wash. 98052); an Intel based SMP server (any vendor) running LINUX, etc.; or SparkStations, etc. (SparkStations is a trademark of and available from Sun Microsystems, Inc., 901 San Antonio Road, Palo Alto, Calif. 94303). In practice, current code is only supported on Windows NT servers but, the ordinarily skilled artisan could readily duplicate this, write their own code, to be supported and run on any platform for processing data and requests to and from enterprise database 532. Enterprise server 530 receives enterprise messages from any one of a number of sources including Web server 540.

Enterprise server 530 may be a symmetric multiprocessor (SMP) system including a plurality of processors connected to a system bus or alternatively, a single processor system may be employed. Also connected to the system bus is a local and memory controller/cache, which provides an interface to the local memory. An I/O bus bridge is connected to the system bus and provides an interface to the I/O bus. Peripheral component interconnect (PCI) bus bridge connected to the I/O bus provides an interface to the PCI bus and a number of modems may be connected to the PCI bus. Communications links to network computers, including Web server 540 and UMDT 504 and or PDTM 514 may be provided through a modem, but more likely, using one of a plurality of network adapters connected to the PCI local bus or the I/O bus. Those of ordinary skill in the art will appreciate that the hardware described above is exemplary and may vary from server to server based, among other factors, on enterprise needs. For example, other peripheral devices, such as optical disk drives and the like, may also be used in addition to or in place of the hardware depicted. The depicted example is not meant to imply architectural limitations with respect to the present invention. Enterprise server 530 may be, for example, an IBM RISC/System 6000 system, a product of International Business Machines Corporation in Armonk, N.Y., running the Advanced Interactive Executive (AIX) operating system.

Enterprise server 530, as depicted in FIG. 5, functions as a database server. Enterprise server 530 processes database storage and retrieval requests from enterprise clients by utilizing an enterprise database management system (DBMS) and for managing information in enterprise database 532. Exemplary DBMSs include Sybase (a trademark of and available from Sybase Inc., 6475 Christie Avenue, Emeryville, Calif. 94608) and Oracle (a trademark of and available from Oracle Corporation, 500 Oracle Parkway, Redwood City, Calif. 94065) for applications on NT/UNIX platforms and also Microsoft SQL Server for NT operating systems (both trademarks and available from Microsoft Corporation). Upon requests from the enterprise clients, such as Web clients 544A-544N, Enterprise server 530 searches enterprise database 532 for selected records and passes them back to the requestor over the network. The implementation of enterprise server 530 allows enterprise data to be requested, modified and imaged at an enterprise level rather than at a sub-enterprise or system level as was common in the prior art. Therefore, rather than the user being forced to access system level information at each one of the separate ancillary umbra systems 502A to 502M, an enterprise user may instead access enterprise level information contained within preumbra/enterprise database 532 through enterprise server 530 via, for example, Web server 540. Moreover, preumbra data may also be retrieved from preumbra/enterprise database 532 rather than an enterprise manager having to become proficient with the ancillary preumbra systems or relying on each ancillary preumbra system to periodically generate hard copy reports that are then circulated to the respective enterprise departments or to migrate all existing ancillary applications, both umbra and preumbra, to an unified enterprise-wide enterprise application platform.

Web server 540 makes World Wide Web services on the Internet available to enterprise server 530. Web server 530 includes hardware and operating systems similar to that described above with respect to enterprise server 530, but also includes Web server software, TCP/IP protocols and the Web site content (enterprise Web pages). Web server 540 is also configured with a firewall for keeping the enterprise network secure from Web born attacks by filtering out unwanted packets. As Web server 540 is actually used internally by the enterprise and not by the public, Web server 540 is actually an intranet server or application server. A primary function of Web server 540 is to manage Web page requests from Web browsers and delivers HTML (Hyper Text Markup Language) documents (enterprise Web pages) in response using the HyperText Transport Protocol (HTTP). Web server 540 also handles all application operations between browser-based computers (any of Web clients 544A-544N) and the enterprise's back-end enterprise applications and enterprise database 532. Additionally, Web server 540 provides all the Internet services necessary to the enterprise, in addition to a HTTP server, Web server 540 functions as a FTP server (file downloads), NNTP server (newsgroups) and SMTP server (mail service). An operating system runs on one or more processors on Web server 540 and is used to coordinate and provide control of various components within. The operating system may be a commercially available operating system such as a UNIX based operating system, AIX for instance, which is available from International Business Machines Corporation. “AIX” is a trademark of International Business Machines Corporation. Other operating systems include OS/2 (a trademark of and available from IBM); Windows NT and Linux (available from Red Hat, Inc., 2600 Meridian Parkway, Durham, N.C. 27713). An object-oriented programming system, such as Java, may run in conjunction with the operating system and provide calls to the operating system from Java programs or applications executing on Web server 540. “Java” is a trademark of Sun Microsystems, Inc. Instructions for the operating system, the object-oriented operating system, and applications or programs are located on local storage devices and may be loaded into main memory for execution by the one or more processors. FIG. 5 depicts Web server 540 and enterprise server 530 as separate enterprise network components however, ordinary artisans will readily understand the one physical server might function as both an application server, database server and a Web server. In accordance with one embodiment, an Intel-based multiprocessor server running Microsoft Windows NT operating system and Internet Information Server (IIS) web server. Web pages are coded with a mixture of HTML and embedded Microsoft VBScript running as Active Server Pages (ASP available from Microsoft Corporation). Web server programs make calls directly to enterprise database 532 via ODBC connection (Open Database Connectivity—this is an industry database connection standard) using the Microsoft ADO (ActiveX Data Objects available from Microsoft Corporation) object model programmatically. The volume of the enterprise requests and/or data growth might dictate that Web “farms” of many connected and synchronized Web servers, as well as a multitude of database servers, to handle the increased volume and throughput. An alternate embodiment would be HTML and Computer Graphics Interface (CGI) based Web site coded in Java, JavaScript (both available from Sun Microsystems Corporation), Practical Extraction Report Language (PERL), etc. with access to the enterprise database via Java Database Connectivity (JDBC available from the Sun Microsystems Corporation), Open Database Connectivity (ODBC available from Microsoft Corporation), connections and related data object models.

In accordance with an exemplary embodiment of the present invention, the enterprise application enables physicians, clinicians and other care providers the means for web-based access to enterprise level functionality and enterprise preumbra data at every workstation connected to the enterprise network within a physical enterprise department. A convention web browser is used for this purpose. By using a web browser over standard Internet connections, authorized users may also securely access the enterprise system from remote locations such as home or office. Every enterprise user is given an enterprise web page that maintains current enterprise content related to the user.

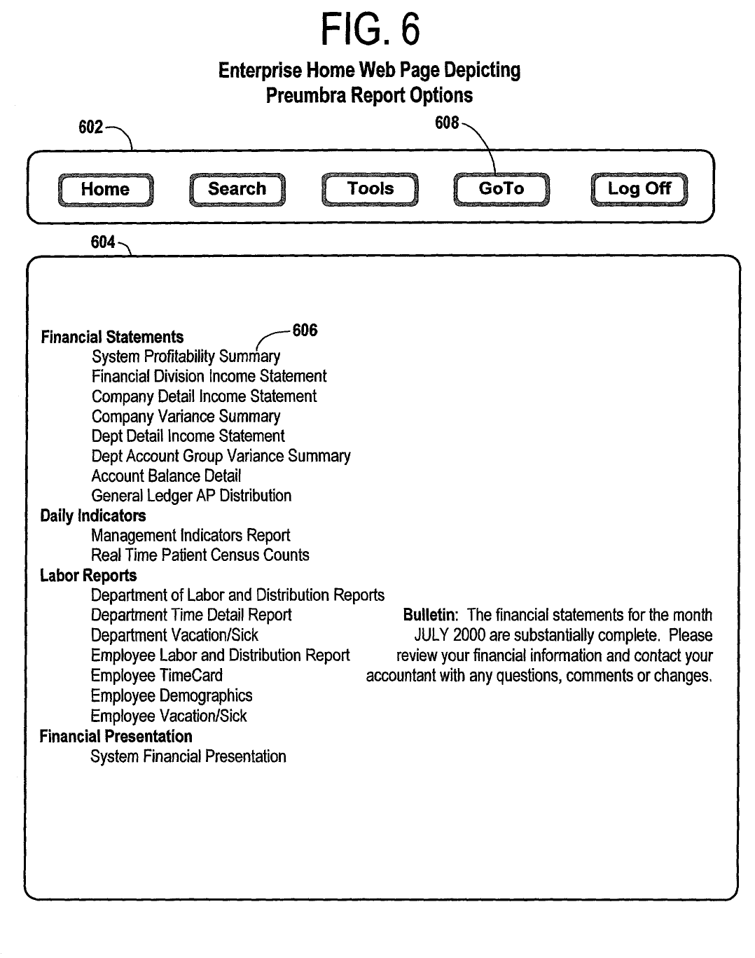

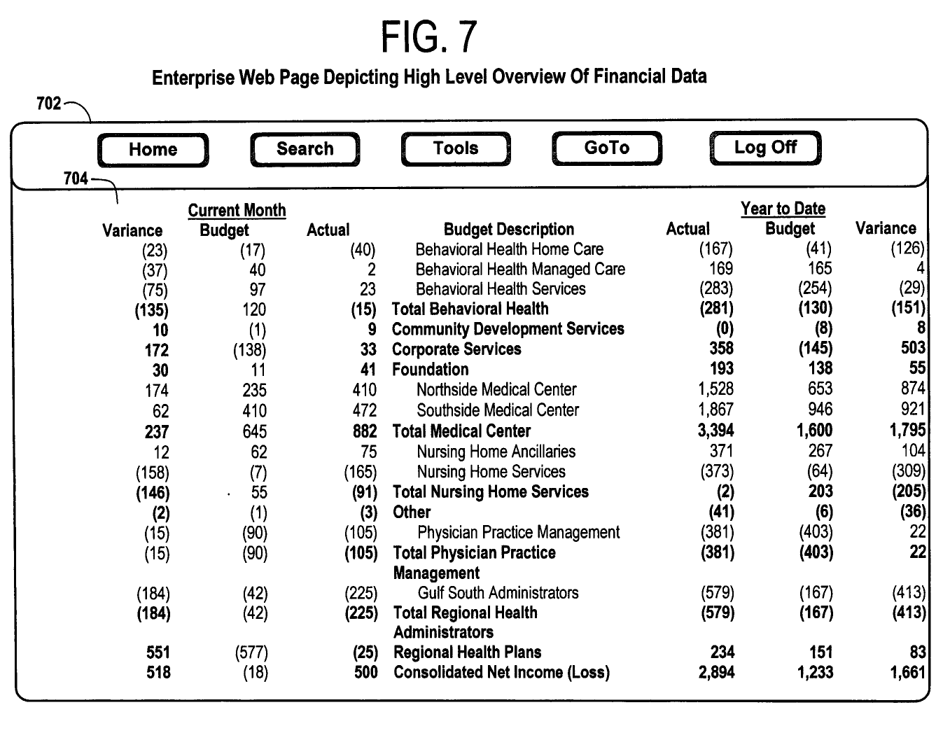

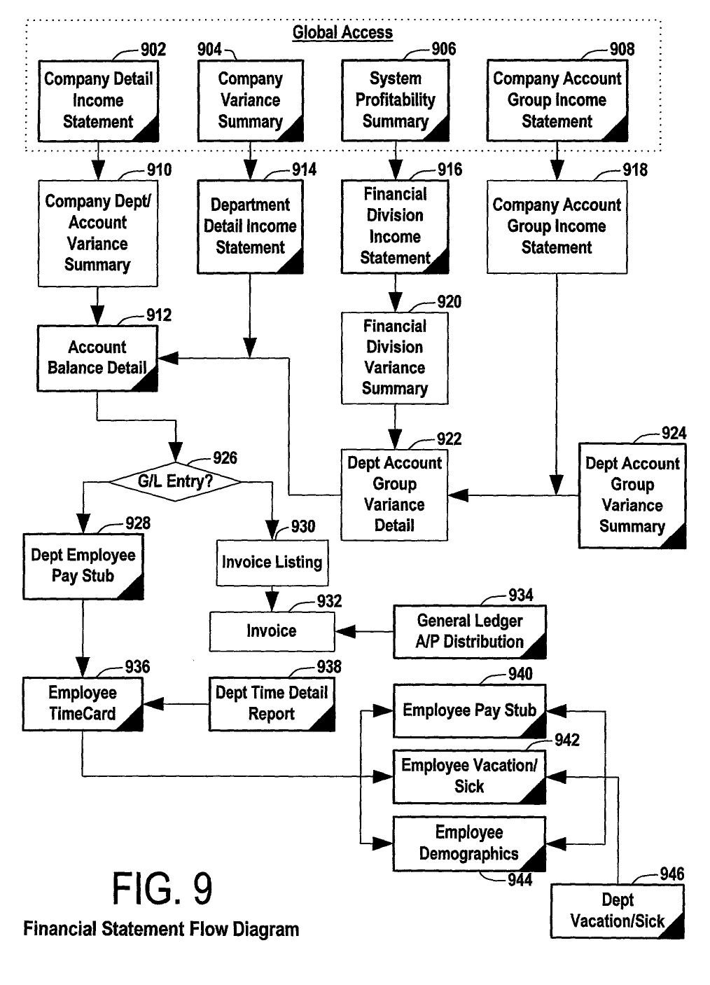

In accordance with an exemplary embodiment of the present invention, enterprise-wide intranet and/or Internet access to enterprise preumbra information via the enterprise application. Alternatively, rather than the enterprise application for handling both umbra and preumbra data security and retrieval, a special purpose preumbra/enterprise application may be used in combination with an umbra/enterprise, the former handling enterprise user access to enterprise preumbra data and the latter for handling access to enterprise umbra data. Preumbra information may be obtained from the enterprise's existing legacy systems such as general ledger, accounts payable, time and attendance and the employee badge system. With the preumbra information organized and consolidated in one place and presented in a single view and displayable from any network PC with a web browser, an enterprise manager can easily and quickly see the overall financial performance of the organization or “drill down” to view specific departmental data. Some exemplar preumbra functionality described herewithin include: System Profitability Summary; Financial Division Income Statement; Company Detail Income Statement; Company Variance Summary; Account Balance Detail; General Ledger AP Distribution; and Daily Dashboard Indicators. Utilizing the “drill down” feature, an authorized enterprise user quickly appreciates the relation of their areas of responsibility to the overall organization because of the enterprise level prospective to the preumbra data that the present invention affords an enterprise user. Linking the reports together gives the user the ability to click on an item in a report and drill down for further information on that one line item. The main purpose of this feature is to allow a user to start at the “system overview” level and drill down on specific line items to help them discern what actual department/account is causing a variance. The manner in which the linked reports allow a user to drill down to the low level preumbra data can be seen with respect to the relationship between the preumbra web pages shown in FIGS. 6 and 7 and is further demonstrated by the financial statement flow diagram depicted in FIG. 9.

Access to preumbra data is granted via the use of user identification and password on a general preumbra data enterprise login page. Typically, access to the functionality of the preumbra/enterprise application is only granted to enterprise employees that have the right to some preumbra data, i.e. financial information for enterprise (general ledger chart of account) areas to which they have budgetary authority. Thus, those enterprise users are normally part of the enterprise management team.

With respect to FIG. 6, a screen shot of the enterprise home page for presenting preumbra data is shown in accordance with an exemplary embodiment of the present invention. In the depicted example, the web page is divided into two parts, functional window 602 containing enterprise preumbra functionality and preumbra information display window 604. Functional window 602 contains executable screen buttons for executing generic preumbra functionality of Home (navigational), Search, Tools, GoTo and Log Off. Here, the user has logged in and been authorized by web server 540 and privilege checked for the user ID by enterprise server 530.

Once authenticated, enterprise users (managers) may select from a variety of preumbra data and functionality such as financial statements or labor reports to which they have budgetary authority. There are three main sections presented to the user: Financial Statements, Labor Reports (H/R reports) and Published Reports. The published reports available to the user gives the client the ability to create any type of document and publish it to the preumbra/enterprise system. The published report is then available to other enterprise users.

Navigation through the preumbra data is accomplished by merely clicking on the desired report or on an entry within a report. In addition, the GoTo feature, shown as 608, is an anywhere from anywhere feature. By using this option, a user can navigate with minimal data entry or mouse clicks to anywhere in the application. It also serves the function of switching from one period view of data to the next (i.e. if viewing the System Profitability Summary for September 2000, it gives the ability to switch to October 2000 view).

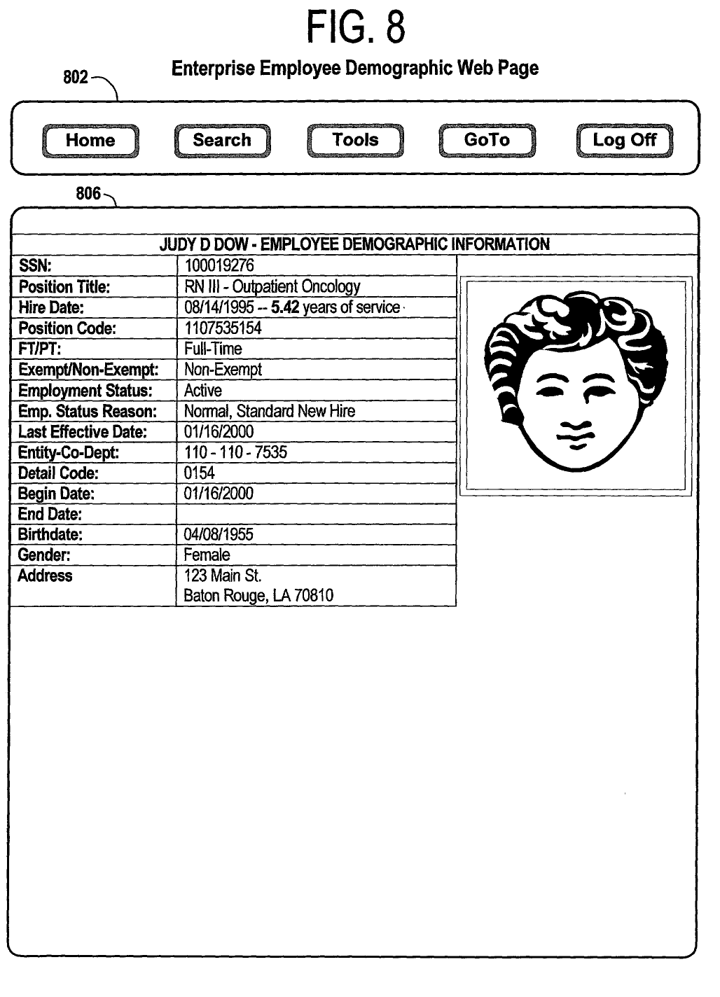

One useful report that summarizes preumbra enterprise data is the System Profitability Summary financial statement, referred to as 606 in FIG. 6. By clicking on the “System Profitability Summary” text are of preumbra information display window 604, the report linked to the text is present to the user. FIG. 7, is a screen shot of the System Profitability Summary financial statement as presented to the enterprise user in accordance with an exemplary embodiment of the present invention. The System Profitability Summary financial statement provides a quick “health of the organization” view. This view of the financial data is especially helpful to the chief executives and senior vice presidents of an organization. The user can navigate from the System Profitability Summary financial statement in the same manner as described above, i.e. clicking on a line item on the report, using the GoTo feature or using the “search” feature for finding a specific document of type of preumbra data entry. Eventually, the user can navigate from reports comprised of higher level preumbra data to reports comprised of the lowest level of preumbra data. With respect to general ledger (GL) type of preumbra data, the lowest level of preumbra data might be found in an individual invoice for an department, while the lowest level of employee type preumbra data might be contained in an employee demographic report, the web page of which is shown on FIG. 8 in accordance with an exemplary embodiment of the present invention. In either case, by using the linked reports structure of the present invention, a user can easily navigate from reports containing the highest level of preumbra data that are available to every manager to reports containing the lowest level of preumbra data that are available to only the managers that have budgetary authority for the data.

FIG. 9 is a flow diagram that illustrates how exemplary reports containing preumbra data are connected to one another in accordance with an exemplary embodiment of the present invention. Table V below lists exemplary preumbra reports and financial statements, along with their descriptions and element numbers as shown in FIG. 9.

TABLE V
(Exemplary Preumbra Report Descriptions)

| Financial Statement | Description | No. |
|---|---|---|
| System Profitability | For all financial divisions, this statement displays the current | 906 |
| Summary | month and year to date net income, budgeted net income and | |
| | variances from budget. | |
| Financial Division | This statement details actual, budget and variance amounts | 916 |
| Income Statement | for the current period and year to date. All figures are | |
| | aggregated to the specified financial grouping. | |
| Financial Division | This statement displays the Variance Summary of a | 920 |
| Variance Summary | specified Financial Division | |
| Dept Account Group | For the selected category this is a comparison of current | 922 |
| Variance Detail | actual to budget income and expense amounts by financial | |
| | statement line. | |
| Company Detail | Overall company statement displays the current month and | 908 |
| Income Statement | year to date income and expenses by account. | |
| Company Account | For the company this is a comparison of current actual to | 918 |
| Group Income | budget income and expense amounts by financial statement | |
| Statement | line. | |
| Company Variance | This statement compares the actual net income to the | 904 |
| Summary | budgeted amount for each department in the company. | |
| Dept Detail Income | For the selected department this statement displays the | 902 |
| Statement | current month and year to date income and expenses by | |
| | account. | |
| Dept Account Group | For the selected department this is a comparison of current | 910 |
| Variance Summary | actual to budget income and expense amounts by financial | |
| | statement line. | |
| Account Balance | This lists the individual activity recorded in each account. | 912 |
| Detail | | |
| General Ledger AP | Invoice listing for a selected Department/Acct. Period, | 934 |
| Distribution | grouped by account. | |
| Department Pay Stub | This report displays the names, ids, pay rates, hours worked | 928 |
| | by pay element, hours paid by pay element, dollars worked | |
| | by pay element and dollars paid by pay element for all | |
| | employees in a specified department. | |
| Dept Time Detail | This report shows employee time by department for a | 938 |
| Report | selected pay period | |
| Dept Vacation/Sick | This report shows the vacation time and sick time hours | 946 |
| | available for each employee in a selected department. | |
| Employee Pay Stub | This report displays the ids, pay rates, hours worked by pay | 940 |
| | element, hours paid by pay element, dollars worked by pay | |
| | element and dollars paid by pay element for a specified | |
| | employee. | |
| Employee Time Card | This report shows the timecard activity for the selected | 936 |
| | employee for the pay period selected. | |
| Employee | This report shows key employee information (i.e. date of | 944 |
| Demographics | hire, title, address, telephone number, employee id, etc.) | |
| Employee Vacation | This report shows the vacation time and sick time hours | 942 |
| Sick | available for the selected employee. | |

With respect to FIG. 9, it can be readily realized how a user can navigate to any lower level statement from any one of the upper level statements by following the arrows from higher levels to lower levels in accordance with an exemplary embodiment of the present invention. Four top-level global access categories consist of a company detail income statement 902, company variance summary 904, system profitability summary 906, and finally, company account income statement 908. These reports are comprised of heavily aggregated preumbra data therefore, a user can get a sense of how the user's department's data affect the overall, aggregated line items in the upper-level reports. Upper-level line items may consist of many individual low-level preumbra data values all aggregated together. It should be noted that in this exemplary embodiment, a user can access any one of the financial statements depicted having a shaded corner in FIG. 9 from a text link on the financial home page. Therefore, most low-level preumbra data is just one or two clicks away. Essentially, a user can navigate to any low-level statement from any high-level statement.

Taking the Company Detail Income Statement 902 for example, line items on the Company Detailed Income Statement are aggregated from lines items on one or more Company Dept/Account Variance Statement 910, which in turn is comprised of aggregated values for line items occurring in one or more entries in the Account Balance Statement 912 and so on.

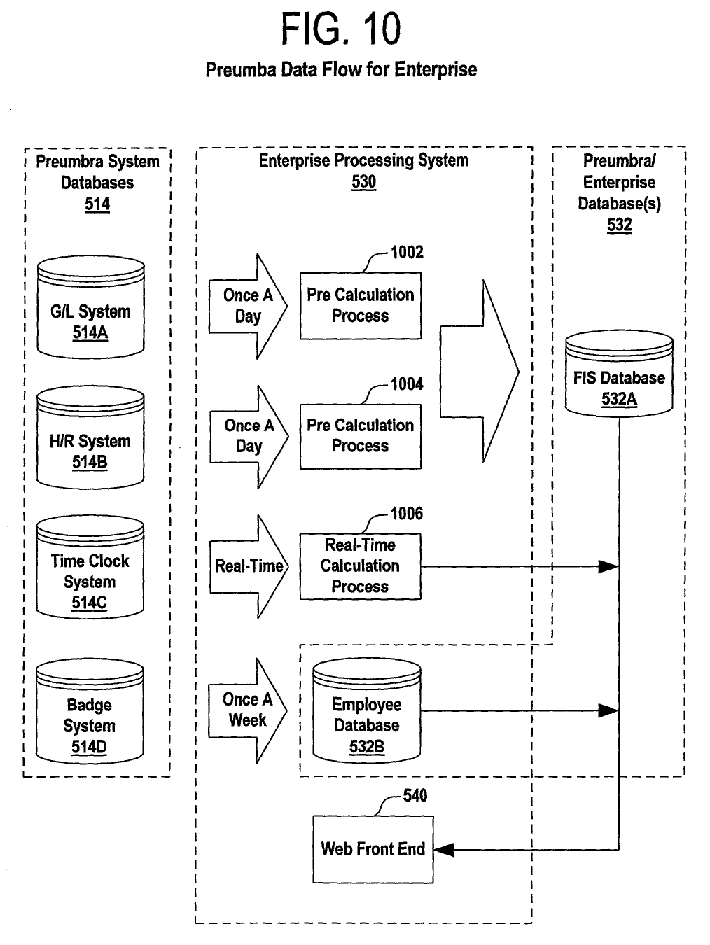

As mentioned above, PDTM 514 may use a number of different data transfer strategies for accessing preumbra data in the individual ancillary preumbra system databases, each within the same enterprise. Individual ancillary preumbra systems may store preumbra data differently even though they are all in the same enterprise. If an ancillary preumbra system maintains preumbra data in its database such that the data is easily accessible and requires little processing, then preumbra data resident in that database might be accessed in real-time by the enterprise application. Conversely, it would be counterproductive to attempt real-time data transfers from ancillary preumbra that maintain their preumbra data in a manner that is not conducive to real-time accessing and processing on the fly. FIG. 10 pictorially represents the data transfer strategy employed by the PDTM in accordance with an exemplary embodiment of the present invention and will be described in conjunction with enterprise system 500 shown in FIG. 5. Notice that each of ancillary preumbra databases 514A-514D is accessed for preumbra data by enterprise processing system 530. However, G/L System 514A and H/R System 514B are accessed once a day. In so doing, enterprise processing system 530 has the extra time needed to perform pre-calculation processes 1002 and 1004. Pre-calculation processes 1002 and 1004 aggregate the preumbra data and otherwise prepare it for presentation prior to saving the processed preumbra data in preumbra/enterprise database 532A. The processed preumbra data is then ready to be returned to a user in real-time. The preumbra/enterprise database is represented as 532A rather than 532 because the preumbra/enterprise database may be physically collocated with enterprise database 532 or might instead be separated from the enterprise database.

On the other hand, Time Clock System 514C is copied directly from the ancillary system database and processed on the fly, in real-time. Enterprise processing system 530 still performs calculation processing on the preumbra data, but in this case, either the amount of calculation processing is minimal and/or the preumbra data is arranged on Time Clock System database 514C such that it is easily acquired. Preumbra data retrieved from Time Clock System database 514C is passed directly to the web front end 540.

In still another data transfer strategy, preumbra data is retrieved from an ancillary preumbra system database, Badge System database 514D, and then written to another database, Employee Database 532B, with little or no processing by enterprise processing system 530 in-between. Enterprise requests for that preumbra data are responded to by accessing Employee Database 532B rather than Badge System database 514D. This data transfer strategy is useful for data and large files such as image files, that do not need updating often. Thus, the images are maintained on a separate database that is not updated often. Using a separate database frees preumbra/enterprise database 532 from transferring numerous large files.

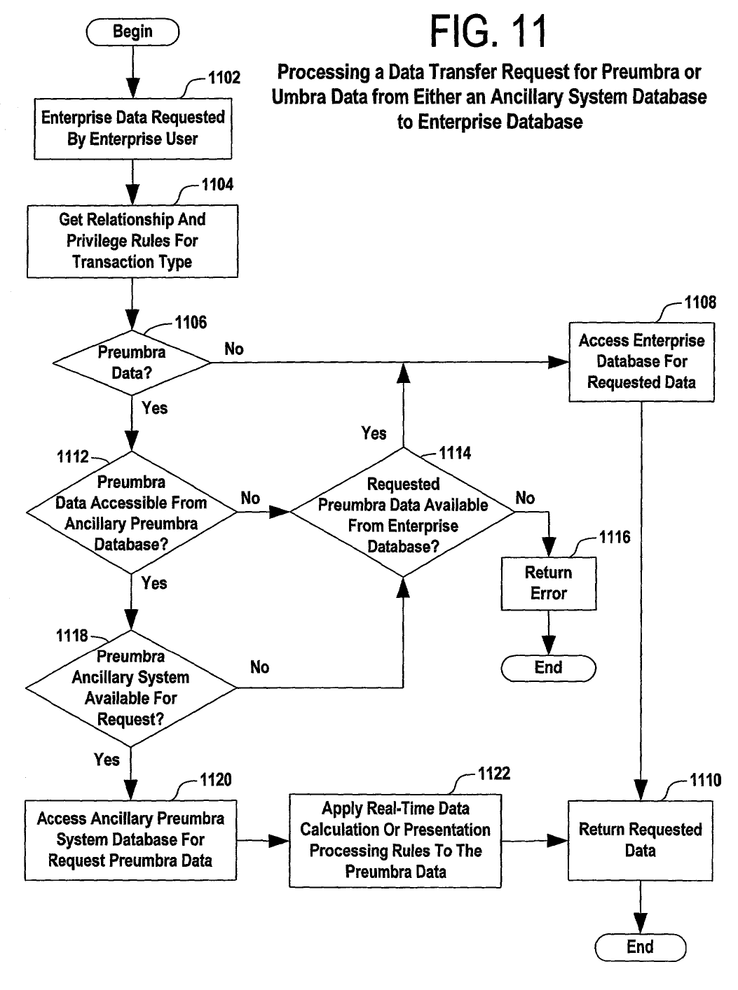

With respect to FIG. 11, a process for transferring data from an ancillary preumbra system database to an enterprise system which handles both umbra and preumbra data is depicted in accordance with an exemplary embodiment of the present invention. The process depicted in FIG. 11 will be described with respect to the enterprise system 500 shown in FIG. 5, however, as discussed with respect to FIG. 5, enterprise system 500 is merely an exemplary network comprising an exemplary combination of typical network elements. It is assumed that the enterprise system is comprised of a plurality of disparate, ancillary systems for the processing of umbra and preumbra data and functionality. It is further assumed that any enterprise message containing a request for data may in fact be a request for one or both of umbra and preumbra data originating from the respective ancillary systems. It is further assumed that all umbra data is available to enterprise server 530 from preumbra/enterprise database 532. Therefore, the enterprise application must be equipped to handle both types of data, umbra and preumbra. However, in accordance with one embodiment of the present invention, preumbra data is available only from the ancillary preumbra system database in which that data originated. Thus, when retrieving that data, it must be accessed directly through the respective ancillary, preumbra system's database. However, the preumbra data may not be organized in the ancillary preumbra system database in a manner that is conductive to retrieving data on the fly. In accordance with other exemplary embodiments of the present invention, preumbra information may be obtained either from the preumbra/enterprise database or the ancillary, preumbra system's database in which that data originated. Obviously, the most expedient course is to retrieve the preumbra data from the preumbra/enterprise database. However, because the preumbra/enterprise database is not automatically populated with preumbra data by event triggered data transfers, the preumbra data within the preumbra/enterprise database may become stale between requests. Thus, preumbra data must be updated in the preumbra/enterprise database at regular intervals (in the case where the enterprise application does not have direct access to the preumbra data in its respective ancillary, preumbra system database) or a mechanism must be implemented within the enterprise application for identifying the preumbra data in the preumbra/enterprise database as being stale. As a general rule, however, it is postulated that because the preumbra enterprise database is not populated with event-triggered preumbra data that the freshest preumbra data is available from the respective ancillary, preumbra system database.

The present process begins with enterprise server 530 receiving a request for enterprise data from an enterprise user (step 1102). As discussed above, it is generally assumed that the enterprise message comes from one of web clients 544A-544N via web server 540, web clients may be connected to the web server through an external Internet or an internal intranet. Upon receiving the request, the enterprise application gets the enterprise relationship rules, privilege rules, preumbra system(s) database access rules and preumbra data processing rules from preumbra/enterprise database 532. The enterprise application processes the enterprise message with the enterprise relationship and privilege rules as described previously in co-pending application titled “Method And System For Assimilating Data From Disparate, Ancillary Systems Onto An Enterprise System,” attorney docket number 017017-620002 and will not be further described here. A check is then made to determine whether the request involves preumbra data (step 1106). If the user request involves only umbra data, enterprise application accesses the enterprise database for the requested data as discussed in detail in the aforementioned co-pending application (step 1108). The requested umbra data is then returned to the requesting enterprise user's client via web server 540.

Returning to decision 1106, should the user request include a request for preumbra data, the enterprise application must then determine whether the preumbra data is directly accessible from an ancillary, preumbra database (step 1112). The enterprise application utilizes the preumbra enterprise database access rules to determine whether or not an ancillary, preumbra system database can be accessed directly for the preumbra data. The preumbra system database access rules are formulated with regard to a number of factors concerning the manner in which the requested preumbra data is stored on its originating ancillary database. These factors include whether or not the preumbra system's database is a relational database or not, whether or not the database structure is a proprietary format, the format of the data itself (flat files, etc.), or whether the structure of the preumbra data on the preumbra database allows for the preumbra data to be processed on the fly. Should the preumbra data not be accessible from an ancillary preumbra database, the enterprise application checks the preumbra/enterprise database for the requested umbra data (step 1114). If the requested umbra data is not available from the preumbra/enterprise database, an error message is returned to the user (step 1116) and the process ends. If, on the other hand, requested preumbra data is available from the preumbra/enterprise database, the process reverts to step 1108 where the enterprise database is accessed for the requested data and the data is returned to the requestor (steps 1108 and 1110).

Returning to decision 1112, if the preumbra data is available directly from an ancillary preumbra database, enterprise application must establish communication with that particular ancillary, preumbra system. Therefore, the process proceeds with a check to determine whether the ancillary preumbra system related to the requested data is available for taking the request. If not, the process flows to decision 1114 where the enterprise application determines whether or not the preumbra data may be accessed from the preumbra/enterprise database. It must be understood that if the data exists on the preumbra/enterprise database, the state of that data may be different from the preumbra data in the ancillary preumbra system database. The preumbra data located in the enterprise database may be older, not as fresh, as the preumbra information available directly from the ancillary preumbra system database. Therefore, although not shown in the figure, a mechanism must be implemented to cull any stale preumbra information from the response to the request. Therefore, if the information is not available in the preumbra/enterprise database, or if the preumbra data contained in the preumbra/enterprise database is stale, an error message will be returned to the requestor (step 1116). If, on the other hand, acceptable preumbra data is available from the preumbra/enterprise database, the data is retrieved by the enterprise application (step 1118) and returned to the requester (step 1110).

Finally, if the ancillary preumbra system is available to the enterprise application at decision 1118, the enterprise application accesses the ancillary system's database for the requested preumbra data. The enterprise application will also apply any necessary preumbra data processing rules previously obtained from preumbra/enterprise database 532, either real time calculation processing or presentation processing (step 1122) prior to returning the requested to the user (step 1110). The process for transferring preumbra data from an ancillary preumbra system database to a requestor then ends.

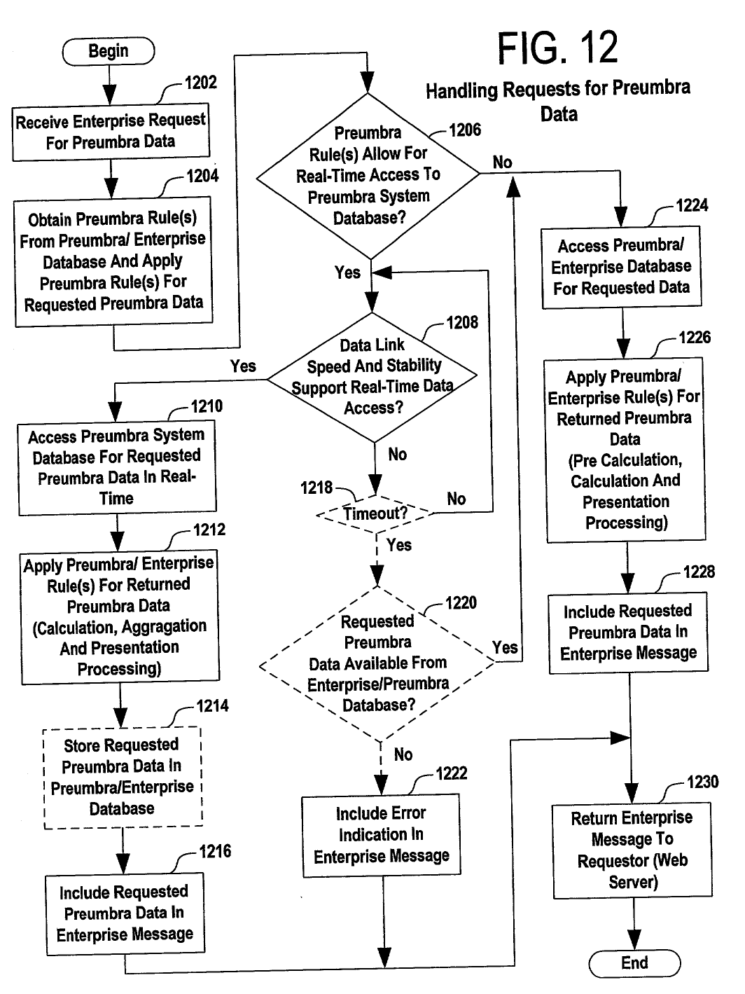

With respect to FIG. 12, a lower level of process for handling requests for preumbra data is depicted in accordance with the preferred embodiment of the present invention. With respect to the present process, it is assumed that the request is limited to a request for preumbra data. The process begins with the enterprise application receiving an enterprise request for preumbra data. The enterprise application then identifies the subject preumbra data and accesses the preumbra enterprise database for preumbra rules associated with the requested preumbra data (step 1204). The enterprise application then checks the rules to determine whether real time access to the respective preumbra system database is called for (step 1206). If the preumbra rules do not allow for access to the preumbra system database, then the requested data must be obtained from the preumbra enterprise database (step 1224). Once the data is retrieved, the enterprise application applies any preumbra rules corresponding to the requested data. These rules may include any data aggregation or presentation processing necessary for the requested data (step 1226). The processed preumbra data is then included in an enterprise message (step 1228) and the enterprise message is returned to the requestor (web server) (step 1230).

Returning to decision 1206, if the preumbra rules allow for the real time acquisition of the requested data from a preumbra system, the data link speed and stability support for accessing the ancillary preumbra system's database is checked. If the state of the ancillary system or the communication network is such that preumbra data cannot be transferred immediately, the enterprise system, rather than immediately issuing an error message, may start a timer for establishing the connection to the preumbra system (step 1218). If a time out occurs, the enterprise application may check the preumbra enterprise database for the requested preumbra data (step 1220). If the requested preumbra data is resident in the preumbra enterprise database, the process reverts to step 1224 and continues from that point as described above. It should be understood that the requested data stored in the preumbra enterprise database may be stale. Therefore, the enterprise application should have a mechanism for identifying the stale data and returning an error rather than returning inaccurate data to the requestor (not shown). If, however, at decision 1220 the requested preumbra data cannot be attained from the preumbra enterprise database, then an error indication is included in the enterprise message (step 1222) and the enterprise message is returned to the requestor (step 1230).

Turning again to decision 1208, once connection is established with the target ancillary, preumbra data system, the preumbra system's database is accessed for the requested data (step 1210). Upon retrieving the preumbra data, the data is processed using any aggregation and presentation processing rules retrieved from the preumbra enterprise database (step 1212). Once the data is processed, it may be stored in the enterprise database (step 1214). Storing the preumbra data in the preumbra/enterprise database is necessary if the preumbra data is not persistent on the ancillary system's preumbra database. However, recall from the data transfer process described in FIG. 11 that the tables containing preumbra data must be first truncated and the indices dropped prior to storing the data and then the tables rebuilt. Regardless, once the preumbra data has been retrieved from the ancillary preumbra system, and it has been aggregated and prepared for presentation, the requested preumbra is included in an enterprise message (step 1216) and the message is returned to the requestor (step 1230). The process then ends.

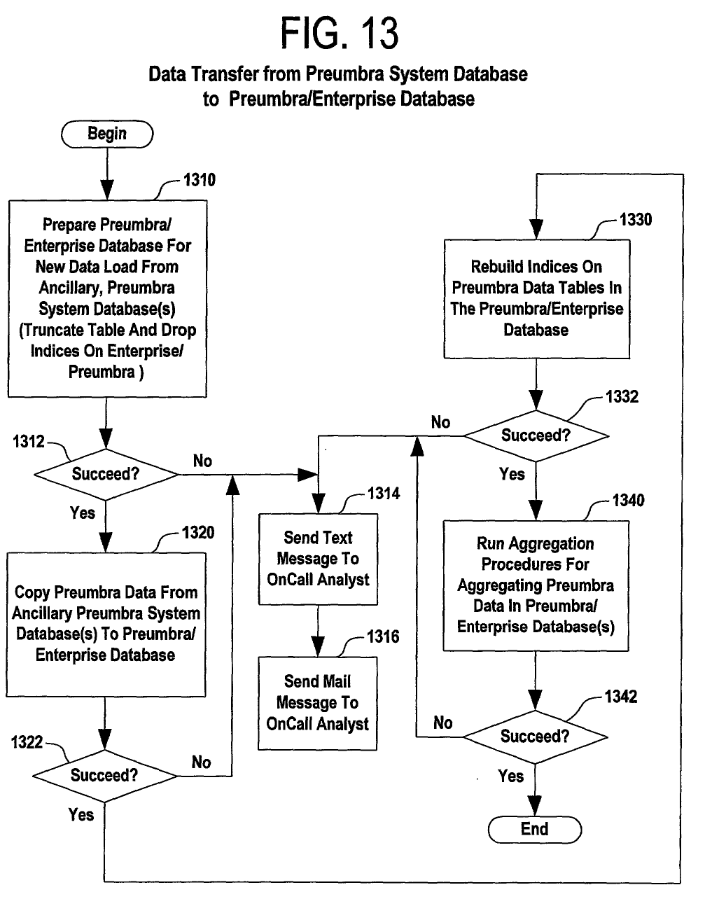

With respect to FIG. 13, flowchart depicting a lower level process for transferring preumbra data from an ancillary preumbra system database to a preumbra/enterprise database is illustrated in accordance with an exemplary embodiment of the present invention. As discussed above, the preumbra/enterprise database is not populated in response to messages generated from trigger events at any one of the ancillary systems. Therefore, preumbra data must be transferred to the preumbra/enterprise database in an overt process executed by the enterprise application. While the enterprise application could retrieve requested preumbra information from the respective ancillary preumbra system database each time a request is received, as mentioned above, in most instances, the preumbra data is not maintained by the ancillary system in a manner that is conducive to real time processing of the preumbra data. Moreover, often the ancillary preumbra system database is structured such that accessing individual data pieces is difficult and time consuming thus expending processing bandwidth for both the enterprise server and the ancillary system. Aside from processing constraints, communication channels between ancillary preumbra systems and the enterprise server may become jammed with requests for individual data pieces from the ancillary system databases. Therefore, in accordance with an exemplary embodiment of the present invention, the enterprise application limits real time retrieval of data to a select type of ancillary system in which the preumbra data is stored in a manner in which the data can be retrieved quickly and processed on the fly in response to a user request. In further accordance with an exemplary embodiment of the present invention, preumbra data is transferred from the respective ancillary preumbra system databases in block data transfers initiated during time periods of low utilization. As a practical matter, most ancillary preumbra system databases are mirrored, or backed up, during the early morning hours, say between midnight and 5:00 a.m., thus most ancillary systems are not available for block transfers during this time period. Therefore, blocks of preumbra data are transferred from the respective ancillary system databases to the preumbra/enterprise database during late night hours, say between 8:00 p.m. and midnight. It should be understood, and as will be brought out with regard to the present process, that a block of data is defined as all new or changed data in the ancillary preumbra system database since the previous successful block transfer.

The process begins by preparing the preumbra/enterprise database for a new load from one or more ancillary preumbra system databases (step 1310). Normally, preparation involves truncating any tables containing preumbra data and dropping indices associated with the data. Because the preumbra enterprise database will not be able to accept any new preumbra data, the previous step being successfully completed, the enterprise application checks for success (step 1312). As a practical matter, there is no automated remedial process should the step not succeed. Therefore, if preparation of the database of the preumbra/enterprise database fails, the enterprise application immediately sends a text message to an on-call analyst (step 1314), and also e-mails the analyst describing the problem (step 1316).

Turning to decision 1312, if the preumbra/enterprise database is prepared for new preumbra data, the enterprise application can then, using the preumbra system database access rules, access preumbra system database for preumbra data and copy same to preumbra/enterprise database (step 1320). Here again, the copy step may or may not succeed depending on a number of factors including ancillary system availability, network availability, or copy period timeout. Thus, the enterprise application again checks to determine whether this step was successful (1322) and if not, once again the enterprise application immediately sends a text message and a mail message to the responsible on-call analyst (steps 1314 and 1316).

Once the preumbra data has been copied to the preumbra/enterprise database, the preumbra data is not necessarily ready for retrieval by the enterprise application. Any tables or indices that were previously deconstructed at step 1310, must be rebuilt (step 1330). Again here the enterprise application checks to see whether or not the tables have been properly rebuilt and indexed (step 1332), and if not, the enterprise application again sends a text message and mail message to the responsible on-call analyst describing the failure (steps 1314 and 1316). If at decision 1332 the tables have been properly re-indexed, the enterprise application will then run any aggregation procedures necessary for aggregating the preumbra data in the preumbra/enterprise database (step 1340). These aggregation procedures may be retained in the preumbra/enterprise database as a preumbra data processing rule and include such exemplary aggregations as including the number of hours worked by an employee since the last block transfer in the employee's payroll information, aggregating the sick time and leave accumulations for the time period, in aggregated open-ended expense and cost parameters with the retrieved values corresponding to those parameters. Finally, the enterprise application determines whether or not the aggregation procedures have been successfully implemented; if not, the responsible on-call analyst is notified via text and mail messages (steps 1314 and 1316). If, on the other hand, the aggregation procedure is successful, the process for transferring preumbra data from a preumbra system database to a preumbra/enterprise database ends.

The following is a partial list of the data load (transfer) events that take place each night between one or more ancillary preumbra system database and the preumbra/enterprise in accordance with an exemplary embodiment of the present invention. The purpose is to move data from one of a number of ancillary preumbra systems to the primary enterprise database. Each data transfer object has a pre-defined task, logic and/or dataset to move.

Load Ledger Accounts and Balances

Load Labor Distribution Report (LDR) pay elements cross references

Load LDR Data (latest pay period)

Load LDR Data (ALL)

Load Journal Lines (previous day)

Load Journal Lines

Load Vacation and Sick Balances

Get Structure Data

Get Employee User Defined Accounting Key (UDAK) data

Extract Reporting Structure Data

Extract Employee Info

Copy Revenue Charge Code Lookup Tables

Collect Pay Period Calendar Data

Extract Invoice Data (previous day)

Extract Invoice Data (All)

With respect to a particular data transfer event, specifically the “Load Ledger Accounts and Balances, the process for describing the transfer event will be discussed in more detail. Initially, at step 1310, prep ss_ledger_acct_bal table prepares the preumbra/enterprise database for the new load, of course although it is not likely, enterprise system 500 might be configured with separate physical databases for umbra and preumbra data, with regard to the example below, the preumbra database is declared as “GHSFIS.”

use GHSFIS

truncate table ss_ledger_acct_bal

IF exists (select 1 from sysindexes

where id=object_id(‘ss_ledger_acct_bal’)

A.ND name=‘ss_ledger_acct_bal_ndx’)

drop index ss_ledger_acct_bal.ss_ledger_acct_bal_ndx

Next, the test is performed at step 1312 and if failed, a text page is sent in accordance with the following.

use GHSMisc

exec spSendTextPage”, ‘DTS Package GHSFIS: Load Ledger Accounts and Balances FAILED on Step 1 of Balance Data Load: truncate ss_ledger_acct_bal and drop indices.’, 1, ‘EAT’

And a mail message is sent in accordance with the following.

use GHSMisc

exec spSendMailMsg”, ‘DTS Package GHSFIS: Load Ledger Accounts and Balances FAILED . . . ’, ‘on Step 1 of Balance Data Load: truncate ss_ledger_acct_bal and drop indices.’, ‘GHSFIS: Load Ledger Accounts and Balances’, ‘EAT’

Upon successfully completing prep ss_ledger_acct_bal table, the ledger account balance detail data is copied to the PREUMBRA/ENTERPRISE database described in step 1320. Essentially, preumbra data is copied from a Primary General Financial database via open database connectivity (ODBC) connection and copied to GHSFIS via the ODBC connection using the following criteria.

select ldr_entity_id,

co, dept, acct, detail, misc,

processing_yr, amt_class_type,

date_lastposted, ldr_amt_{—}0,

ldr_amt_{—}1, ldr_amt_{—}2, ldr_amt_{—}3,

ldr_amt_{—}4, ldr_amt_{—}5, ldr_amt_{—}6,

ldr_amt_{—}7, ldr_amt_{—}8, ldr_amt_{—}9,

ldr_amt_{—}10, ldr_amt_{—}11, ldr_amt_{—}12,

ldr_amt_{—}13, ldr_amt_{—}14

from DBSglep.dbo.ldr_acct_bal

where processing_yr>=(datepart(yy, getdate( )))-2

Again the test is performed at step 1322 and if failed, a text page and mail message are sent in accordance with to the description above. When select ldr_entity_id is successfully executed, then the indexes on ledger account balance tables are rebuilt for improved application performance as follows at step 1330.

use GHSFIS

create clustered index ss_ledger_acct_bal_ndx

on ss_ledger_acct_bal (ldr_entity_id, co, dept, acct, detail, processing_yr, amt_class_type)

with fillfactor=100

After successfully indexing the tables at step 1330, the aggregation procedure(s) is called to prepare data for application and user consumption as follows at step 1340.

use GHSFIS

exec sp_BuildAccountGroups

exec sp_GenerateIncomeData

exec sp_BuildCompanyIncome

exec sp_GenerateCompanyCategoryTotals

The test is performed for the last time. At step 1340, the enterprise application will call scripts that manipulate the data which was pulled from the ancillary preumbra system such that its existence in the enterprise database is conducive to the application and ultimately, the end users corporate need. These scripts exist as stored procedures in the preumbra/enterprise database, but one of ordinary skill in the art would readily realize that other scripts could be created using the present script as an exemplar. The following is an example script (sp_BuildAccountGroups)

/*

′**

′**

′** sp_BuildAccountGroups

′**

′** execute this stored procedure to take the contents of ss_reporting_structure

′** and format its data into a non-recursive format. for example, the table

′** contains the following fields . . .

′**

′** [parent_point_id], [point_id], [point_tier], [point_name], [descp]

′**

′** the point_id is simply the id of the current record. the parent_point_id points to

′** the point_id of another record in the table, thus telling us who the ‘parent’ of

′** the current record is. the point tier column tells us at what level the record falls in

′** the hierarchy. for example, point tier 2 is a major group (such as OPERATING

′** EXPENSES), point tier 3 is a minor group (such as Routine Services) and point

′** tier 4 is an account which falls under point tier 3. in this stored proc, we will

′** dump our point tier 2 records into a temp table, dump our tier 3 records into another

′** temp table, then extract our point tier 4 records, joining our previous temp

′** tables, and place the ‘flattened’ record into a permanent table that can be queried by

′** sp_GetAccountGroups . . .

′**

*/

PRINT ‘starting to build AccountGroups data’
/*
‘**
‘**
‘**
‘**step #1
‘**
‘**we need to check to see if there is a table AccountGroups
in our database. this table’** will hold the data generated
by this stored procedure. another procedure,
‘**sp_GetAccountGroups, can be called to pull data from this table in an
organized
‘**manner . . . we need to see if this object exists in our database and if it
doesn't, we
‘**will create it . . .
‘**
‘**
*/
IF NOT(EXISTS(SELECT * FROM sysobjects WHERE name =
‘AccountGroups’))
BEGIN

| PRINT ‘table AccountGroups not found, creating table’ | | |
|---|---|---|
| CREATE TABLE AccountGroups | | |
| ( | | |
| tier1_link | char(4) | null, |
| tier2_link | char(4) | null, |
| tier3_link | char(4) | null, |
| tier4_link | char(4) | null, |
| tier2_major_group_name | char(240) | null, |
| tier2_major_group_description | char(255) | null, |
| tier3_minor_group_name | char(240) | null, |
| tier3_minor_group_description | char(255) | null, |
| tier4_account_name | char(240) | null, |
| tier4_account_description | char(255) | null |
| ) | | |

END

/*

′**

′**

′** step #2

′**

′** we may inadvertently have a temp table lying around—if so, we need to remove it . . .

′**

′** we will extract data from ss_reporting_structure where the point_tier is 2. this will

′** give us our major group codes such as OPERATING REVENUE, DEDUCTIONS

′** FROM REVENUE, etc. . . .

′**

′**

*/

IF EXISTS(SELECT*FROM tempdb.dbo.sysobjects WHERE name=‘##accountgroups_tier2’)

BEGIN

DROP TABLE ##accountgroups_tier2

PRINT ‘dropped temp table accountgroups_tier2’

END

SELECT

ss_r_s.parent_point_id as tier1_link,

ss_r_s.point_id as tier2_id,

ss_r_s.point_name as tier2_name,

ss_r_s.descp as tier2_descp

INTO

##accountgroups_tier2

FROM

ss_reporting_structure ss_r_s

WHERE

(ss_r_s.point_tier ‘2’)

ORDER BY

ss_r_s.point_id

/*

′**

′**

′** step #3

′**

′** we may inadvertently have a temp table lying around—if so, we need to remove it . . .

′**

′** we will extract data from ss_reporting_structure where the point_tier is 3 AND the

′** parent point id is not 1. this is because there are some records in the

′** ss_reporting_structure table in which the parent_point_id is 1 and the point_tier is 3,

′** but there is no record in this table where the point_id is 1, thus there nothing to tie

′** to . . . any record with a point_tier of 3 should point to a record with a point tier of 2.

′** this will give us our minor group codes such as Service Revenue and Outpatient

′** Services . . .

′**

′**

*/

IF EXISTS(SELECT * FROM tempdb.dbo.sysobjects WHERE name=‘##accountgroupstier3’)

BEGIN

PRINT″

DROP TABLE ##accountgroups_tier3

PRINT ‘dropped temp table accountgroups_tier3’

END

SELECT

ag_t2.tier2_id as tier2_link,

ss_r_s.point_id as tier3_id,

ss_r_s.point_name as tier3_name,

ss_r_s.descp as tier3_descp

INTO

##accountgroups_tier3

FROM

##accountgroups_tier2 ag_t2,

ss_reporting_structure ss_r_s

WHERE

(ag_t2.tier2_id=ss_r_s.parent_point_id) and

((ss_r_s.point_tier=‘3’) and (ss_r_s.parent_point_id<>‘1’))

ORDER BY

ag_t2.tier2_id, ss_r_s.point_id

/*

′**

′**

′** step #4

′**

′** our AccountGroups table may have information from a previous data load, we need to ′* * remove its contents. since this is not a real-time system, we can just truncate the table

′** instead of executing a delete statement (which will utilize the transaction log).

′**

′** we now will extract data from ss_reporting_structure where the point_tier is 4, joining

′** into the temp table ##accountgroups_tier3 to get our ‘parents’ information, also

′** joining into the other temp table ##account_groups₁₃ tier2 to get our ‘grandparents’

′** information. this ‘flattened’ record layout will then be inserted into the

′** AccountGroups table . . .

′**

′**

*/

—DELETE FROM AccountGroups

TRUNCATE TABLE AccountGroups

PRINT ‘removed previous dataload from AccountGroups’

INSERT INTO AccountGroups

(

tier1_link,

tier2_link,

tier3_link,

tier4_link,

tier2_major_group_name,

tier2_major_group_description,

tier3_minor_group_name,

tier3_minor_group—description,

tier4_account_name,

tier4_account_description

)

SELECT

ag_t2.tier1_link,

ag_t3.tier2_link,

ss_r_s.parent_point_id,

ss_r_s.point_id,

ag_t2.tier2_name,

ag_t2.tier2_descp,

ag_t3.tier3_name,

ag_t3.tier3_descp,

ss_r_s.point_name,

ss_r_s.descp

FROM

ss_reporting_structure ss_r_s,

##accountgroups_tier2 ag_t2,

##accountgroups_tier3 ag_t3

WHERE

(ag_t3.tier3_id=ss_r_s.parent_point_id) and

(ag_t3.tier2_link=ag_t2.tier2_id) and

(ss_r_s.point_tier=‘4’)

ORDER BY

ag_t3.tier2_link,

ag_t3.tier3_id,

ss_r_s.point_id

/*

′**

′** Step #5

′** clean up code, remove our temporary tables—we no longer need them.

′**

′**

*/

IF EXISTS(SELECT * FROM tempdb.dbo.sysobjects WHERE name=‘##accountgroups_tier3’)

BEGIN

PRINT″

DROP TABLE ##accountgroups_tier3

PRINT ‘dropped temp table accountgroups_tier3’

END

IF EXISTS(SELECT * FROM tempdb.dbo.sysobjects WHERE name ‘##accountgroups_tier2’)

BEGIN

PRINT″

DROP TABLE ##accountgroups_tier2

PRINT ‘dropped temp table accountgroups_tier2’

END

PRINT ‘finished building AccountGroups data . . . ’

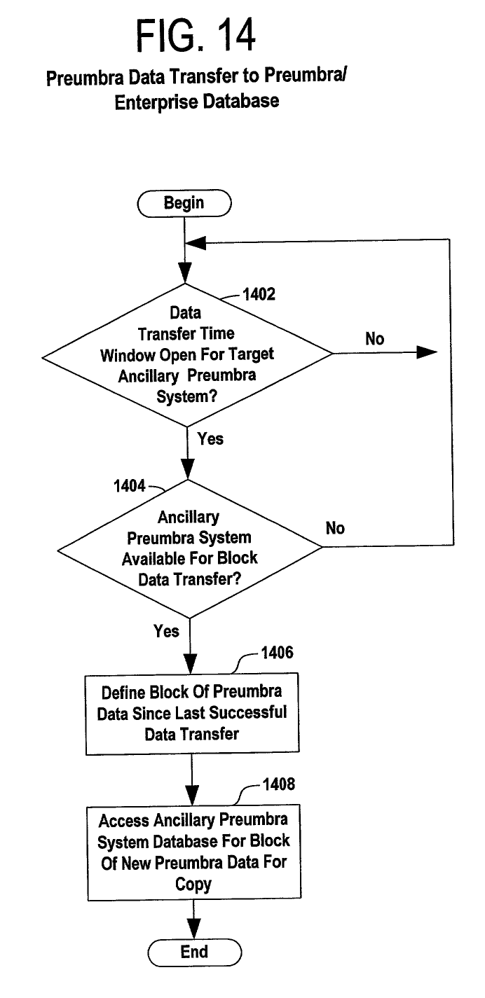

As briefly discussed above, it is expected that many of ancillary preumbra systems within enterprise system 500 are accessed daily by enterprise applications, although depending on the data, they may be accessed biweekly or even weekly. As a practical matter, downloading a block of preumbra data is time consuming and resource intensive. Therefore, transfer is normally scheduled for late night hours. With respect to FIG. 14, a high-level process is depicted for other than real time transfers of block data in accordance with an exemplary embodiment of the present invention. Process begins with the enterprise application checking its internal clock for the scheduled time window for a target ancillary preumbra system (step 1402). The process continually loops until the time window opens for the target ancillary preumbra system. Then the enterprise application checks that the ancillary preumbra system is available for a data transfer (step 1404). If the target ancillary preumbra system is busy or unavailable, the process reverts to step 1402 for rechecking the time window prior to again checking the target ancillary preumbra system for availability. Once the target system is available, a data block of preumbra data is defined which includes all data that has been updated or changed since the last successful data transfer (step 1406). Finally, the enterprise application accesses the ancillary preumbra system database for the block of new preumbra data (step 1408). The process then ends.

The data structure for storing preumbra data in preumbra/enterprise database 532 accommodates a general ledger (GL) key of four levels. In accordance with one exemplary embodiment that key consist of Entity, Company, Department and Account level as shown in Table V below.

TABLE VI
(GL Key Levels)

| Entity | Company | Departments | Accounts | Description |
|---|---|---|---|---|
| 1 | 1 | <all departments> | <all accounts> | Hospital |
| | | | | Facility 1 |
| 1 | 2 | <all departments> | <all accounts> | Hospital |
| | | | | Facility 2 |
| 2 | 2 | <all departments> | <all accounts> | Physican |
| | | | | Office Bldg. |
| 3 | 1 | <all departments> | <all accounts> | Gift Shop |

In the above example, all departments for Hospital Facility 1 would fall under the high level GL key of Entity/Company=1/1. And the same would also hold true for each of the other GL keys. The GL structure is a standard hierarchical structure, when referencing only an entity level, everything with that entity is included. Most of the reports work off this key structure. The report is either for an Entity, an Entity/Company, an Entity/Company/Department or an Entity/Company/Department/Account. With the account level being the lowest for the financial statements.

Due to the way most organizations view their data, another “grouping” of these keys was developed inside of the enterprise. This grouping, called Financial Divisions, allows GL keys to be grouped outside of the standard hierarchy. In the above example, Hospital Facility 1 and the Physician Office Building may physically exist on the same campus. From a senior management point of view, seeing the entire campus together would be an advantage. Therefore, a Financial Division could be created which included 1/1 and 2/2. This way, income statements could be viewed for the entire division and not as two separate statements.

The enterprise system of the present invention utilizes two different methods for securing preumbra data from unauthorized viewing. The first is overall application security, which handles basic access to the application. The other is report security, which manages the access to the different GL keys and reports.

Application security refers to the place where each user is defined by a user ID and password. This security is maintained in a separate database. Each ID may exist in any number of groups. These groups are used throughout the application to define access rules for functions. For example, a group is used to secure the bulletin update feature in the enterprise. Only users whose ID is in the update bulletin group may access the update page and update the home page bulletin. This group security is also used to secure the management of the Report Security functionality. The application security links to the report security via the employee ID as defined within the preumbra system database (514). When an ID is created in the application security the employee ID is also required.

Report security is managed by the GL key and a report ID key. The highest level reports in the financial statements are considered global access. Every enterprise manager has access to reports designated for global access.

Security is defined by the GL key Entity/Company/Department (E/C/D). Each ID has associated with it a list of E/C/D combinations, which the ID has access too. If a request is department level, the entire key is checked (E/C/D) (for example, the user has requested a department income statement). If the report is Entity, Company or Financial Division in level, the user must have access to a department, which belongs to that group either by the GL hierarchy or by the Financial Division grouping (for example, the user has requested a financial division income statement).

For security to the employee information, a reporting structure is imported from the H/R system. This system lists all employees and who they report to, much like an upside down tree structure with the CEO on the top.

TABLE VII
(GL Key Levels)

| Employee ID | Employee | Manager ID |
|---|---|---|
| 4 | Employee 4 | 2 |
| 5 | Employee 5 | 2 |
| 2 | Employee 2 | 1 |
| 6 | Employee 6 | 3 |
| 7 | Employee 7 | 3 |
| 3 | Employee 3 | 1 |
| 1 | Employee 1 | |
| | (CEO) | |

In Table IVV, each employee has an entry in the database with a corresponding employee ID. The manager ID reference indicates the employee ID of the manager for that employee.

The preumbra/enterprise application flattens this structure and makes it so a manager has a list of all employees they are privileged to view. For example:

TABLE VIII
(GL Key Levels)

| Manager ID | Employee ID |
|---|---|
| 1 | 2 |
| 1 | 3 |
| 1 | 4 |
| 1 | 5 |
| 1 | 6 |
| 1 | 7 |

Exceptions also exist for report security. In the case where an employee clocks in under a department different from their home department, an exception rule exists. When a manager views the “Labor Distribution Report” (a payroll report), the employee will show up there. By strict interpretation of the rules, the manager may not have access to that employee (to view time card, demographics, etc. . . . ). The exceptions allow for the scenario whereby an employee is being paid by a department where the manager has budgetary responsibility. It is important to note that this manager may not have direct responsibility for this employee, but in this case the employee's compensation may be paid out of this manager's GL key. The fact that this manager's area of responsibility is paying the wages of this employee's work event provides the non-supervising manager with access by default.

For example, with respect to the example above, employee ID 3 is a manager with access to employee IDs 6 and 7. Under normal circumstances, manager ID 3 is not privileged to view employee ID 4. But if employee ID 4 clocks in under a department managed by manager ID 3, the resulting excepting rule will allow manager ID 3 to view employee ID 4's employee information.

Each report is given a report ID key. In some cases, it is necessary to give a manager access to a GL key. But for a business reason, it might be necessary to disallow access to one or more reports for the manager. By default, when a user is granted access to the GL key, they can see everything associated with the GL key (all reports). The security administrator of the preumbra database has the ability to remove certain reports from view privilege at the GL key and report level. For example, manager A has access to GL keys 1/1/8000 and 2/2/5500. An entry can be added which will block manager A from viewing the “Department Payroll Report” for 2/2/5500. This report is still available for viewing by manager A for 1/1/8000.

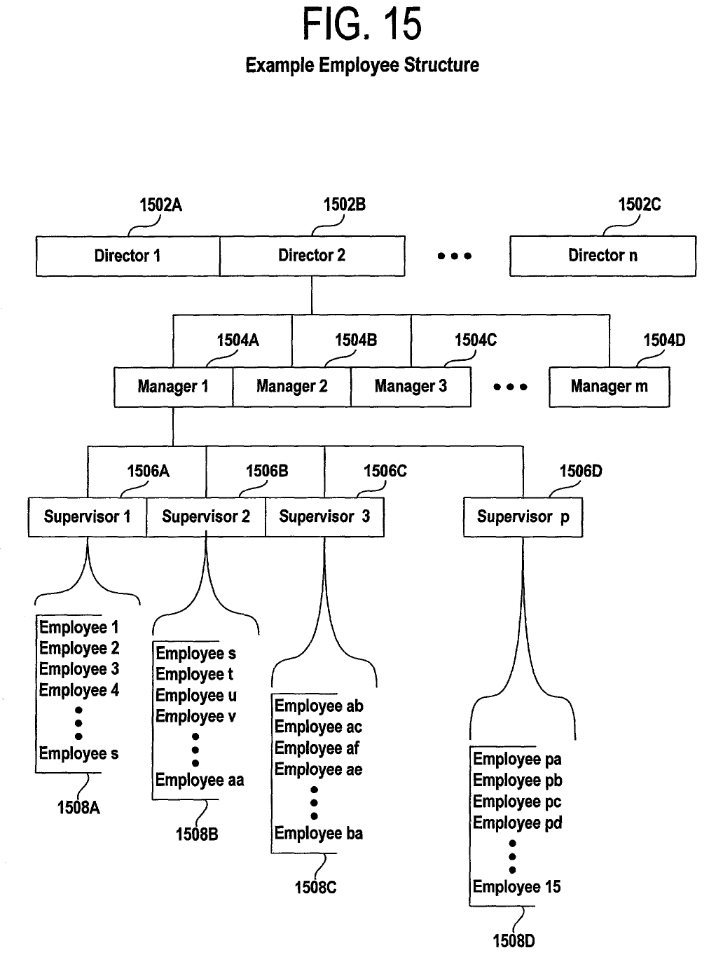

As alluded to in several passages above, the security of preumbra information is a major concern for an enterprise. Unauthorized access of preumbra information is not only detrimental to the enterprise, but can also be demoralizing for the enterprise employees. On one hand, users must be granted access to all the preumbra information necessary for managing enterprise personnel under their direction, but on the other hand, it is the view of most professionals that granting authorization to peer information causes disharmony among the enterprise personnel. One mechanism employed by the present invention for ensuring that unauthorized users do not get access to preumbra data is that of grouping an enterprise user with the group from which the user receives a paycheck. This principle can be better understood with respect to the diagram on FIG. 15.

With respect to FIG. 15, an exemplary employee structure is depicted and might be found in a typical enterprise. The depicted employee structure may be any one of a number of well known enterprise structures such as line management, line and staff management, etc. FIG. 15 illustrates a hierarchical enterprise employee that begins with the highest level depicted at the director level 1502. It is apparent from the diagram that each management node defines an inverted tree structure of subordinates. A director, manager or supervisor is at the head of each inverted tree structure of subordinates.

Taking director 2 1502B for example, subordinate structure consisting of a plurality of managers 1504A-1504D, and every enterprise employee in managers 1504A-1504D inverted tree structure, or in their respective management lines. With respect to manager 1 1504A, supervisors 1-P are accountable to manager 1, and thus in manager 1 1504A management line. In turn, each supervisor handles a predefined group of employees, in case of supervisor 1 1506A, employees 1508A include employees 1-S. Each of supervisor 1's employees, employees 1-S are also in manager 1's management line and finally in director 2's management line. However, notice that while manager 1 is in director 2's management line, manager 1 does not have budgetary authority to that management line. Conversely, manager 1 does have budgetary authority for all enterprise employees listed below manager 1's position on the employee structure because those employees are in manager 1's management line. Therefore, as a general rule, manager 1 can see any preumbra data related directly to the management line for which manager 1 has budgetary authority because of manager 1's position in the management chain. However, manager 1 cannot see any low level preumbra data that manager 1 does not have budgetary authority, such as employees in to the manager's management lines. This is also true for manager 1's peers, i.e. managers 2-m, because those managers are not in manager 1's management line but instead, are in director 2's line.

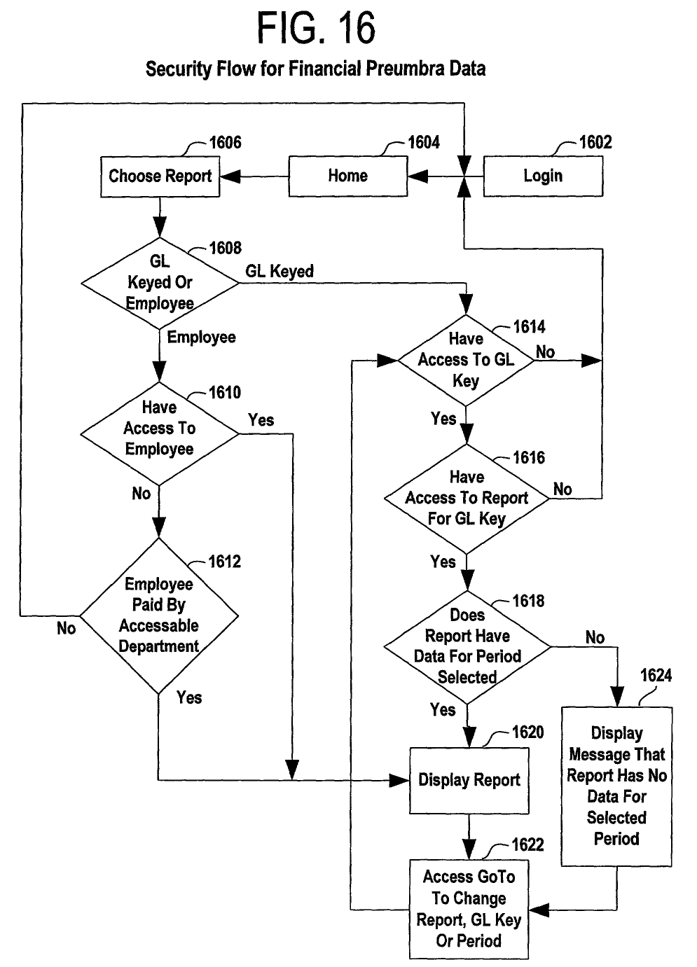

Referring now to FIG. 16, a flowchart depicting security flow for financial preumbra data is depicted in accordance with an exemplary embodiment of the present invention. Accessing financial preumbra data through the enterprise web page begins with a successful log-in step 1602, at which point an enterprise financial home page is presented to the enterprise user similar to the exemplar in FIG. 6. Then from the financial home page, the user can select a detailed report to be presented (step 1606). At that point, the security system determines whether the requested report is general ledger (GL) keyed or employee keyed (step 1608). The user must have the appropriate authorization for the type of report selected, i.e. either the proper GL keys or be properly situated in the management structure. If, for instance, the user has selected an employee report, the security system identifies the user's position in the management structure from the user's log-in ID and then whether the user has authority to the requested report for that employee by virtue of the user's position in the management line (step 1610). If, for example, the user is the employee's supervisor or above the employee in the direct management line, then the user will be granted access to the report (step 1620). If the user is not in the employee's line management, the security system checks to see whether the employee is paid by the user's accessible department (step 1612). Sometimes, an employee may temporarily work for one department while being permanently attached to another department. In those cases, the employee is paid by the department for which the employee is temporarily working and that manager needs to track the employee's preumbra data. If the employee is neither in the user's management line or being paid by the department managed by the user, then the user has no budgetary authority to see the employee's preumbra data and therefore, the financial home page is once again displayed to the enterprise user allowing the user to reselect an accessible report (step 1604).

Returning to decision 1608, if the report chosen by the enterprise user is GL keyed, the enterprise security system first checks to see if the user has access to any GL key (step 1614). If the user has no GL keys than the user cannot have a GL key for the particular report being requested thus, the financial home page is redisplayed to the user (step 1604). If, however, at step 1614 the user does have access to GL keys, then the security system checks to see if the user has access to the requested report for the GL key (step 1616). There may be management reasons that although the user has the GL key to access the request report, that the user is denied access to the report. In that case, the user cannot see the preumbra data on the report. Again, if the user does not have the prerequisite authorization, the financial home page is redisplayed (step 1604). If, on the other hand, the enterprise user has access to the report for the GL key, then the enterprise application can check for preumbra data for the period selected by the user (step 1618). If preumbra data exists, then the report is displayed (step 1620). If not, a message is displayed informing the user that there is no data for the selected period attributable to the report selected by the user (step 1624). Finally, any time the enterprise security system determines that the enterprise user has prerequisite authority for the presentation of a financial report whether the report contains data or not. The security system allows the user to change the report GL key or period of the report using the go to function (step 1622). At that point, the process reverts to step 1614 where the security system determines whether or not the enterprise user has access to the GL key for the newly selected report. The process continues as described above until the user logs off.

Returning to 1608, the login functionality is managed by the enterprise security model. The enterprise security model is a two-tier component object that can be embedded into an application program and is designed to provide full authentication services to these applications in accordance with a preferred embodiment of the present invention. The two tiers in the object are the business logic tier and the database access tier.

The business logic tier is the piece of the object that is instantiated by the application and in turn, acts as a liaison between the application layer and the security model. Here, the application can request authentication services for an end user (step 1602). Once the end user has been authenticated, certain security settings and/or privileges can be accessed and validated before proceeding with standard application functionality. For example, management of the application security, as defined in steps 1608 through 1612 and steps 1614 through 1616. Also, given the proper level of authority, changes to the user's authentication settings can be made at this level, etc. The business tier also has the capability of logging all security and/or application data access points.

The database access tier contains all the standard I/O routines for database access. Calls from the embedded client object (mentioned previously) are passed to this database access tier via COM interfaces. All I/O to the security model's supporting database must be made through this client object layer. This prevents unauthorized database changes and eliminates errors and omissions to the authentication database.

Together, these tiers expose both standard and complex security interfaces (methods and properties) that the application can call. With this embedded authentication layer, the application is free to validate all user permissions and rights before granting access to any (if not all) application features.

The enterprise security model is split up into a data access component (GHSSecurityServer2) and a business logic\state component (GHSSecurityClient). From a programming point of view, code will interact with the business logic component (GHSSecurityClient) and this component in turn will communicate with the data access component (GHSSecurityServer2) via Microsoft Transaction Server. This is a brief overview of each component. The GHSSecurityServer2 component reads the registry on the installed machine to pull its database connection information. By doing this, things like database, user Id and password that the GHSSecurityServer2 needs to establish a connection can be changed.

This UserServer interface handles the actual user data access/manipulation needs of the Security Model. This is a ‘stateless’ object, meaning that it is meant to be created, perform the desired task(s) and then die. Connection management is handled via MTS (Microsoft Transaction Server is a product and trademark of Microsoft Corporation and is available from Microsoft Corporation. An update of this DLL (provided that the interface has not changed) normally means shutting down the package in MTS, copying over the new DLL and then refreshing all components in MTS. On the installation machine (TESTNET/GNET), you will find an icon on the desktop (REGGIE) which launches a program that you can use to manipulate the registry values used by this object. The keys used by this object are as follows:

[image]

[image]

[image]

[image]

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application and to enable others of ordinary skill in the art to understand the invention for various embodiments with various modifications as are suited to the particular use contemplated.

What is claimed is:

1. A data processing system implemented method for managing data from a plurality of ancillary systems comprising:
receiving a request for a value of a data item;
identifying an ancillary system associated with the requested data item;
determining whether data stored in the ancillary system is conducive to being processed into the value;
retrieving the data from one of the ancillary systems and the data processing system based on whether data stored in the ancillary system is conducive to being processed into the value;
processing the data into the value for the data item; and
returning the requested value for the data item.

2. The data processing system implemented method recited above in claim 1, wherein the data is retrieved from the data processing system, the method further comprises:
identifying all data updated in the ancillary system since a last block transfer of data to the data processing system;
requesting a block transfer of updated data from the ancillary system; and
copying the block of updated data to the data processing system.

3. The data processing system implemented method recited above in claim 2, wherein processing the data into the value for the data item is performed subsequent to copying and prior to receiving the request.

4. The data processing system implemented method recited above in claim 2, wherein processing the data into the value further comprises aggregating the data into a value for the data item.

5. The data processing system implemented method recited above in claim 1, wherein the data item is financial information.

6. The data processing system implemented method recited above in claim 2, wherein the data processing system further comprises rules for managing data, said rules comprise:
rules for identifying an ancillary system that is associated with a data item; and
rules for determining whether data stored in the ancillary system is conducive to being processed into the value.

7. The data processing system implemented method recited above in claim 1, wherein the data is retrieved from the ancillary system, and retrieving the data further comprises:
attempting to contact the ancillary system;
querying the ancillary system for the data; and
receiving the data from the ancillary system.

8. The data processing system implemented method recited above in claim 1, wherein retrieving the data from one of the ancillary systems and the data processing system further comprises:
attempting to contact the ancillary system based on the data stored in the ancillary system being conducive to being processed into the value; and
receiving the data from the ancillary system based on the ancillary system being unresponsive.

9. The data processing system implemented method recited above in claim 2, wherein the ancillary system is a first ancillary system and the request is a first request for a first value for a first data item, the method further comprises:
receiving a second request for a value of a second data item;
identifying a second ancillary system associated with the second data item;
determining whether data stored in the second ancillary system is conducive to being processed into the value;
retrieving the data from the second ancillary system based on the data stored in the second ancillary system being conducive to beinging processed into the value;
processing the data into the value for the second data item; and
returning the requested value for the second data item.

10. The data processing system implemented method recited above in claim 1 further comprises:
catching a message, wherein the message was generated by an ancillary system using a set of content rules and the message conforms to a message standard;
opening the message;
identifying the ancillary system based on the message;
accessing content conversion rules based on the identity of the ancillary system;
converting content from the message to enterprise information using the content conversion rules; and
storing the enterprise information in the data processing system.

11. The data processing system implemented method recited above in claim 7, wherein the ancillary system is a first ancillary system and the request is a first request for a first value for a first data item, the method further comprises:
receiving a second request for a value of a second data item;
identifying a second ancillary system associated with the second data item;
determining whether data stored in the second ancillary system is conducive to being processed into the value;
retrieving the data from the data processing system based on the data stored in the second ancillary system not being conducive to being processed into the value;
processing the data into the value for the second data item; and
returning the requested value for the second data item.

12. The data processing system implemented method recited above in claim 1, wherein the data item is a line item in a document.

13. The data processing system implemented method recited above in claim 1, wherein the data item relates to financial information, and the financial information is in a document.

14. The data processing system implemented method recited above in claim 1, wherein prior to identifying an ancillary system associated with the requested data item the method comprises:
calling a security model for requester security information;
receiving the requestor security information from the security model; and
accessing a security key related to the requested data item based on the requestor security information.

15. The data processing system implemented method recited above in claim 1, wherein prior to identifying an ancillary system associated with the requested data item the method comprises:
determining whether the data item relates to employee information or financial information;
accessing management organizational information; and
determining whether to return the requested data item value based on the requestor having access to the employee information.

16. The data processing system implemented method recited above in claim 14, further comprises:
prior to calling a security model for requester security information, determining whether the data item relates to employee information or financial information; and
determining whether to return the requested data item value based on the security key.

17. The data processing system implemented method recited above in claim 2, prior to identifying all data updated in the ancillary system since a last block transfer of data to the data processing system the method further comprises:
monitoring a clock for a predetermined time interval.

18. The data processing system implemented method recited above in claim 1, wherein the ancillary system is a first ancillary system and the request is a first request for a first value for a first data item, the method further comprises:
receiving a second request for the value of a second data item;
identifying an auxiliary datastore associated with the second data item; and
retrieving the value for the data item from the auxiliary datastore.

19. The data processing system implemented method recited above in claim 18 further comprises:
identifying an ancillary system related to the auxiliary datastore;
identifying all data updated in the ancillary system since a last block transfer of data to the auxiliary datastore;
requesting a block transfer of updated data from the ancillary system; and
copying the block of updated data to the auxiliary datastore.

20. The data processing system implemented method recited above in claim 1, wherein the data is retrieved from the data processing system, the method further comprises:
identifying all data updated in the ancillary system since a last block transfer of data to the data processing system;
truncating a data table in the data process system, wherein the data table contains data items derived from the data stored in the ancillary system;
requesting a block transfer of updated data from the ancillary system;
copying the block of updated data to the data processing system; and
reconstructing the data table with the updated data.

21. A computer-readable storage medium storing program instructions for execution on a data processing system which when executed cause the data processing system to perform a method for managing data from a plurality of ancillary systems comprising:
receiving a request for a value of a data item;
identifying an ancillary system associated with the requested data item;
determining whether data stored in the ancillary system is conducive to being processed into the value;
retrieving the data from one of the ancillary system and the data processing system based on whether data stored in the ancillary system is conducive to being processed into the value;
processing the data into the value for the data item; and
returning the requested value for the data item.

22. The computer-readable storage medium recited above in claim 21, wherein the data is retrieved from the data processing system, the method further comprises:
identifying all data updated in the ancillary system since a last block transfer of data to the data processing system;
requesting a block transfer of updated data from the ancillary system; and
copying the block of updated data to the data processing system.

23. The computer-readable storage medium recited above in claim 22, wherein processing the data into the value for the data item is performed subsequent to copying and prior to receiving the request.

24. The computer-readable storage medium recited above in claim 22, wherein processing the data into the value further comprised aggregating the data into a value for the data item.

25. The computer-readable storage medium recited above in claim 21, wherein the data item is financial information.

26. The computer-readable storage medium recited above in claim 22, wherein the data processing system further comprises rules for managing data, said rules comprise:
rules for identifying an ancillary system that is associated with a data item; and
rules for determining whether data stored in the ancillary system is conducive to being processed into the value.

27. The computer-readable storage medium recited above in claim 21, wherein the data is retrieved from the ancillary system, and retrieving the data further comprises:
attempting to contact the ancillary system;
querying the ancillary system for the data; and
receiving the data from the ancillary system.

28. The computer-readable storage medium recited above in claim 21, wherein retrieving the data from one of the ancillary systems and the data processing system further comprises:
attempting to contact the ancillary system based on the data stored in the ancillary system being conducive to being processed into the value; and
receiving the data from the ancillary system based on the ancillary system being unresponsive.

29. The computer-readable storage medium recited above in claim 22, wherein the ancillary system is a first ancillary system and the request is a first request for a first value for a first data item, the method further comprises:
receiving a second request for a value of a second data item;
identifying a second ancillary system associated with the second data item;
determining whether data stored in the second ancillary system is conducive to being processed into the value;
retrieving the data from the second ancillary system based on the data stored in the second ancillary system being conducive to being processed into the value;
processing the data into the value for the second data item; and
returning the requested value for the second data item.

30. The computer-readable storage medium recited above in claim 21 further comprises:
catching a message, wherein the message was generated by an ancillary system using a set of content rules and the message conforms to a message standard;
opening the message;
identifying the ancillary system based on the message;
accessing content conversion rules based on the identity of the ancillary system;
converting content from the message to enterprise information using the content conversion rules; and
storing the enterprise information in the data processing system.

31. The computer-readable storage medium recited above in claim 27, wherein the ancillary system is a first ancillary system and the request is a first request for a first value for a first data item, the method further comprises:
receiving a second request for a value of a second data item;
identifying a second ancillary system associated with the second data item;
determining whether data stored in the second ancillary system is conducive to being processed into the value;
retrieving the data from the data processing system based on the data stored in the second ancillary system not being conducive to being processed into the value;
processing the data into the value for the second data item; and
returning the requested value for the second data item.

32. The computer-readable storage medium recited above in claim 21, wherein the data item is a line item in a document.

33. The computer-readable storage medium recited above in claim 21, wherein the data item relates to financial information, and the financial information is in a document.

34. The computer-readable storage medium recited above in claim 21, wherein prior to identifying an ancillary system associated with the requested data item the method comprises:
calling a security model for requester security information;
receiving the requester security information from the security model; and
accessing a security key related to the requested data item based on the requester security information.

35. The computer-readable storage medium recited above in claim 21, wherein prior to identifying an ancillary system associated with the requested data item the method comprises:
determining whether the data item relates to employee information or financial information;
accessing management organizational information; and
determining whether to return the requested data item value based on the requestor having access to the employee information.

36. The computer-readable storage medium recited above in claim 34, further comprises:
prior to calling a security model for requestor security information, determining whether the data item relates to employee information or financial information; and
determining whether to return the requested data item value based on the security key.

37. The computer-readable storage medium recited above in claim 22, prior to identifying all data updated in the ancillary system since a last block transfer of data to the data processing system, the method further comprises:
monitoring a clock for a predetermined time interval.

38. The computer-readable storage medium recited above in claim 21, wherein the ancillary system is a first ancillary system and the request is a first request for a first value for a first data item, the method further comprises:
receiving a second request for a value of a second data item;
identifying an auxiliary datastore associated with the second data item; and
retrieving the value for the data item from the auxiliary datastore.

39. The computer-readable storage medium recited above in claim 38 further comprises:
identifying an ancillary system related to the auxiliary datastore;
identifying all data updated in the ancillary system since a last block transfer of data to the auxiliary datastore;
requesting a block transfer of updated data from the ancillary system; and
copying the block of updated data to the auxiliary datastore.

40. The computer-readable storage medium recited above in claim 21, wherein the data is retrieved from the data processing system, the method further comprises:
identifying all data updated in the ancillary system since a last block transfer of data to the data processing system;
truncating a data table in the data process system, wherein the data table contains data items derived from the data stored in the ancillary system;
requesting a block transfer of updated data from the ancillary system;
copying the block of updated data to the data processing system; and
reconstructing the data table with the updated data.

41. An enterprise data processing system for managing ancillary data from a plurality of ancillary systems comprising:
an enterprise data processor;
an enterprise database for storing data, ancillary system access rules, and ancillary data processing rules, said enterprise database being operationally connected to said enterprise data processor;
an ancillary system data transfer mechanism for transferring data from a plurality of ancillary systems based on whether data stored in an ancillary system is conducive to being processed into a data item value, said ancillary system data transfer mechanism being operationally connected to the plurality of ancillary systems.

42. The enterprise data processing system recited above in claim 41, wherein the ancillary system data transfer mechanism identifies all data updated in the ancillary system since a last block transfer of data to the enterprise database;
requesting a block transfer of updated data from the ancillary system; and
copying the block of updated data to the enterprise database.

43. The enterprise data processing system recited above in claim 42, wherein the ancillary system data transfer mechanism processes the data into the data item value subsequent to copying.

44. The enterprise data processing system recited above in claim 42, wherein the ancillary system data transfer mechanism processes the data into the value further comprising an aggregator for aggregating the data into a value for the data item.

45. The enterprise data processing system recited above in claim 41, wherein the data item is financial information.

46. The enterprise data processing system recited above in claim 42, wherein the enterprise database stores rules for identifying an ancillary system that is associated with a data item and rules for determining whether data stored in the ancillary system is conducive to being processed into the value.

47. The enterprise data processing system recited above in claim 41, wherein the ancillary system data transfer mechanism further comprises:
communication connections for contacting the ancillary system and receiving data therefrom; and
logic for querying the ancillary system for the data; and
receiving the data from the ancillary system.

48. The enterprise data processing system recited above in claim 41, wherein the enterprise is a healthcare provider.

49. The enterprise data processing system recited above in claim 1 further comprises:
an automated interface for catching messages and redirecting the messages to the ancillary system data transfer mechanism.

50. The enterprise data processing system recited above in claim 1, wherein the data item relates to either enterprise employee information or financial information.
